(19) United States
(12) Patent Application Publication
(10) Pub. No.: US 2026/0278872 A1
(43) Pub. Date: Sep. 17, 2026

(54) INTELLIGENT GENERATION OF ANALYTICS PRESENTATIONS BASED ON INSIGHTS EXTRACTED FROM ANALYTICS DATA AND NARRATIVE GROUPINGS

(71) Applicant: Adobe Inc., San Jose, CA (US)

(72) Inventors: Jane Elizabeth Hoffswell, Seattle, WA (US); Prithvi Bhutani, Lynnwood, WA (US); Abhisek Trivedi, Lehi, UT (US); Wei Zhang, Great Falls, VA (US); Eunyee Koh, Sunnyvale, CA (US); Shunan Guo, San Jose, CA (US); Victor Soares Bursztyn, Redwood City, CA (US); William Brandon George, Pleasant Grove, UT (US); Trevor Hyrum Paulsen, Lehi, UT (US)

(21) Appl. No.: 19/080,712

(22) Filed: Mar. 14, 2025

(51) Int. Cl. G06T 11/60

(52) U.S. Cl. CPC G06T 11/60; G06T 2200/24

(57) ABSTRACT

The present disclosure relates to systems, methods, and non-transitory computer-readable media that generates a digital presentation from a set of insights. Furthermore, the disclosed systems generate a set of insights from data extracted from an analytics application by using an intelligent captioning model. Moreover, the disclosed systems generate narrative grouping structures from the set of insights by grouping insights together based on similarity scores of the set of insights. Further, the disclosed systems generate a digital presentation outline according to the narrative grouping structures. From the digital presentation outline, the disclosed systems generate a digital presentation.

### BACKGROUND

Recent years have seen significant improvements in hardware and software platforms for generating digital visualizations from large digital data repositories. To illustrate, conventional systems often collect and manage large digital data volumes including, for example, computer device interactions with digital content deployed across the internet or other computer networks. In some implementations, conventional systems receive user interactions with various interface elements to build digital visualizations from these large digital data volumes. Although conventional systems generate digital visualizations, such systems suffer from a number of technical deficiencies including inefficiency, inaccuracy, and operational inflexibility of implementing computing devices.

As just mentioned, conventional systems often suffer from computational inefficiencies. For example, the amount of analytics data a system may collect for even a single website or application may be difficult to manage or mine due to its overwhelming volume. To create visualizations of data, conventional systems require client devices to perform an excessive number of interactions. For instance, conventional systems require administrator devices to identify the correct data features and portions of analytics data based on user interactions with a variety of graphical user interfaces and interactive elements. Moreover, analysts are further tasked with manually extracting the most important insights and data in order to create an engaging and interpretable presentation of the created visualizations.

Furthermore, conventional systems further suffer from computational inefficiencies due to excessive shuffling between various user interfaces. For example, as mentioned, the amount of analytics data typically collected results in a large volume of data. As such, administrator devices in prior systems typically must switch between multiple different software applications to create visualizations, create presentations, and ensure that the created presentations have a sufficient amount of data and accurately reflect data within the created visualizations. As such, conventional systems consume an excess amount of time and resources in attempting to present/interpret extracted data from an analytics application.

Relatedly, in one or more implementations, prior systems suffer from computational inaccuracies. For example, as mentioned, conventional systems typically require analysts to switch between multiple different software applications. This process often results in incorrectly identifying data attributes and generating inaccurate and incomplete data visualizations (e.g., selecting the wrong visualization or failing to correctly select the correct data attributes) when creating a digital presentation to present certain interpretations of the data. Moreover, in some embodiments, analysts take screenshots of data visualizations, which results in created presentations containing illegible/distorted visualizations of the data.

Furthermore, in one or more implementations, prior systems suffer from stale or out-of-date data. For example, prior systems work with/manage large volumes of analytics data and analysts create digital presentations from large volumes of data. In particular, an analyst creates a digital presentation in preparation for a presentation, but by the time it is time to present, the digital presentation is already out of date due to the changes that occur in the analytics data. Thus, prior systems suffer from computational inaccuracies in generating digital presentations due to the dynamic nature of analytics data.

Moreover, in one or more implementations, prior systems suffer from operational inflexibility. For example, as mentioned, prior systems are rigidly limited to generating presentations of data visualizations based on user interactions and shuffling between multiple different interfaces. In other words, prior systems rely on a user correctly identifying relevant portions of data and ensuring that that information is accurately portrayed in a digital presentation. Accordingly, prior systems are typically limited to generating presentations of data visualizations utilizing rigid processes limited to time constraints and data sifting capabilities of analysts.

### SUMMARY

This disclosure describes one or more embodiments that provide benefits and/or solve some or all of the foregoing problems with systems and methods that performs intelligent, content, and style-aware generation of digital presentations. For example, in one or more embodiments, the disclosed systems automatically generate digital presentation slides from an analytics application (e.g., an analytics dashboard). In particular, the disclosed systems generate a set of insights from data extracted from an analytics application, generates narrative grouping structures from the set of insights, and further generates a digital presentation based on the narrative grouping structures. Thus, the disclosed systems provide an end-to-end framework for seamlessly transforming analytics data into presentable slides.

In certain embodiments the disclosed systems further provides a user specified parameter for an analyst to select from, such that the disclosed systems filter down a set of insights according to the user specified parameter. Specifically, the disclosed systems generate a digital presentation based on a subset of insights that are selected according to the user specified parameter. Furthermore, the disclosed systems at inference time provide on-the-fly generation of additional digital slides to add to a digital presentation. In particular, the disclosed systems provide a digital presentation prompting interface for a presenter to prompt the disclosed systems to perform updates to the digital presentation, perform comparisons of data within the digital presentation, or to create a new slide with additional insights to add to the digital presentation.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a digital presentation generation system operates in accordance with one or more implementations;

FIG. 2 illustrates an overview of the digital presentation generation system generating a set of insights from analytics data and further generating a digital presentation from the set of insights in accordance with one or more implementations;

FIGS. 3A-3C illustrates an example diagram of a digital analytics system generating an analytics dashboard from data collected via monitoring a third-party application in accordance with one or more implementations;

FIG. 4 illustrates an example diagram of the digital presentation generation system utilizing an intelligent captioning model to generate a set of insights in accordance with one or more implementations;

FIG. 5 illustrates an example diagram of the digital presentation generation system ranking a set of insights and selecting a subset of insights in accordance with one or more implementations;

FIG. 6 illustrates an example diagram of the digital presentation generation system generating narrative grouping structures from a subset of insights in accordance with one or more implementations;

FIG. 7 illustrates an example diagram of the digital presentation generation system utilizing a presentation generation model to generate a digital presentation from a digital presentation outline in accordance with one or more implementations;

FIG. 8 illustrates an example diagram of the digital presentation generation system providing a digital presentation prompting interface to a presenter in accordance with one or more implementations;

FIG. 9 illustrates an example diagram of the digital presentation generation system comparing data from a first timeframe with data from a second timeframe and generating a comparison slide in accordance with one or more implementations;

FIGS. 10A-10C illustrates example graphical user interfaces displaying digital presentations generated by the digital presentation generation system in accordance with one or more implementations;

FIGS. 11A-11B illustrates example graphical user interfaces displaying a digital presentation and a digital presentation prompting interface in a digital presentation in accordance with one or more implementations;

FIG. 12 illustrates a schematic diagram of the digital presentation generation system in accordance with one or more implementations;

FIG. 13 illustrates a flowchart of a series of acts for generating a digital presentation in accordance with one or more implementations;

FIG. 14 illustrates a block diagram of an exemplary computing device in accordance with one or more implementations.

### DETAILED DESCRIPTION

This disclosure describes one or more embodiments of a digital presentation generation system that automatically generates (in an end-to-end manner) a digital presentation from an analytics dashboard or other data sources. In particular, the digital presentation generation system receives input data from an analytics application and generates a set of insights using an intelligent captioning model. The digital presentation generation system further groups and orders the insights based on topics using a ranking model. Moreover, in some embodiments, the digital presentation generation system filters the set of insights during ranking based on a user specified parameter. Additionally, in some embodiments, the digital presentation generation system generates narrative grouping structures from the set of insights/subset of insights and further generates digital presentation slides from the narrative grouping structures. In particular, the digital presentation generation system customizes the digital presentation to match the context and style of an overall narrative of the insights to be visualized in a digital presentation.

As mentioned above, in one or more implementations, the digital presentation generation system selects analytics insights to include in a digital presentation. Indeed, in one or more implementations, the digital presentation generation system provides for configurable and automatic (e.g., without further user input) insight extraction, ranking, and selection. In one or more implementations, the digital presentation generation system receives a user specified parameter (e.g., one or more dimension values of interest) and selects insights from a set of insights based on the user specified parameter. In other words, the digital presentation generation system modifies the ranking/selection of insights in response to receiving a user specified parameter. Thus, in some embodiments, an analyst guides (e.g., via the user specified parameter) the digital presentation generation system in selecting insights from a set of insights to generate a digital presentation.

In some embodiments, the digital presentation generation system further generates an overall narrative structure. In particular, the digital presentation generation system generates narrative grouping structures from the insights. For example, the digital presentation generation system identifies highly related insights to group together in single slide or a single section of the digital presentation. In particular, the digital presentation generation system determines how to group together insights to reduce repeated visualizations and adds sections to a digital presentation to provide a larger overarching structure. Moreover, the digital presentation generation system determines shifts in topics between different slides to determine different sections of a digital presentation.

Additionally, in some embodiments, the digital presentation generation system further performs data filtering and highlighting within a digital presentation. In particular, the digital presentation generation system intelligently determines how much content to show in each digital slide (e.g., to keep the slide legible) and further highlights key values within a digital slide (e.g., to enhance the presentability of a digital slide). Moreover, the digital presentation generation system also generates presenter notes (e.g., to present via a presenter note interface) to enhance the efficiency of a presenter presenting digital slides.

Moreover, in some embodiments, the digital presentation generation system performs presentation updates. In particular, the digital presentation generation system allows a presenter to submit prompts to update data shown in a digital presentation and/or to add new content to a digital presentation. Thus, the digital presentation generation system provides on-the-fly tools to further enhance the presentation of a digital presentation.

As mentioned above, conventional systems suffer from a variety of issues in relation to inefficiency, inaccuracy, and operational inflexibility. The digital presentation generation system provides a variety of technical benefits relative to such conventional systems. For example, in one or more embodiments, the digital presentation generation system improves efficiency of implementing devices by reducing excess interactions to create data visualizations and to further create presentations from the visualizations.

Although the digital presentation generation system also works with a large volume of data, in some embodiments, the digital presentation generation system uses an intelligent captioning model to generate insights from the large volume of data. Further, the digital presentation generation system further creates an overall narrative structure of the insights by generating narrative grouping structures. Specifically, in some embodiments, the digital presentation generation system generates the digital presentation based on the narrative grouping structures (e.g., a digital presentation outline of the narrative grouping structures). As such, in some embodiments, the digital presentation generation system effectively parses through and interprets a large volume of data to create a coherent narrative for a digital presentation.

Moreover, in one or more embodiments, the digital presentation generation system further improves efficiency by eliminating the need for excessive shuffling between various interfaces (e.g., to create digital slides that contain visualizations and interpretations of the visualizations). Indeed, in one or more embodiments, the digital presentation generation system obviates the time-consuming process of filtering and embedding visualizations/data into an editable presentation format. In particular, the digital presentation generation system generates the set of insights, the narrative grouping structures from the set of insights, and a digital presentation from the narrative grouping structures.

Thus, in one or more implementations, the digital presentation generation system intelligently transforms visualizations in an analytics dashboard into notable insights and maps those insights into a digital presentation. Accordingly, the digital presentation generation system improves efficiency of digital presentation tasks by providing a streamlined framework for going from an analytics dashboard directly to a ready for presentation digital presentation (e.g., in some embodiments, the digital presentation contains presenter notes and labels indicating hidden values).

Further, in one or more embodiments, the digital presentation generation system further improves upon accuracy by generating insights from digital data visualizations that accurately reflect pertinent attributes and features and then transforms those insights into a digital presentation. For example, the digital presentation generation system generates digital presentations with accurate data visualizations that are presented in an efficient manner (e.g., the digital presentation generation system filters out certain values). Accordingly, in one or more embodiments, the digital presentation generation system accurately generates digital presentations that reflect desired characteristics indicated by an analyst.

Moreover, in one or more embodiments, the digital presentation generation system further improves upon operational flexibility. As mentioned above, existing systems rely on repeated user interactions (e.g., drag and drop operations from analytics dashboards to a presentation application) to identify data attributes and features to create a digital presentation. In contrast, the digital presentation generation system establishes an end-to-end pipeline that receives as input the data from the analytics application and outputs a digital presentation that captures (in an efficient and accurate manner) the data from the analytics application. As such, in some embodiments, the digital presentation generation system provides enhanced operational flexibility in generating digital presentations that do not rely on shuffling between multiple different interfaces and on particular interactions with selectable options in an analytics application.

As demonstrated from the discussion above, the current application uses a variety of terms and phrases to describe the digital presentation generation system. In one or more embodiments, “data” refers to information collected and processed by an analytics application (e.g., a software platform). In particular, the data refers to user interaction data such as clickstream data (e.g., clicks, views, interactions), engagement metrics (e.g., session duration), satisfaction (e.g., survey results collected from users), conversions (e.g., purchases, downloads), payment information, sales data, user demographics, and customer profiles. For example, the digital presentation generation system monitors various third-party software platforms, collects the data, processes the data, and provides tools for creating dashboards (e.g., visualizations) of the data. In some embodiments, the digital presentation generation system categorizes the data according to dimensions (e.g., descriptive or categorical aspect of data to filter down the data) and metrics (quantitative measurements or numerical values that are used to evaluate performance).

In one or more embodiments, a “dimension” refers to a qualitative attribute or characteristic to categorize digital events. In particular, the dimension refers to different category types for the extracted data (e.g., digital events in the analytics application). For instance, the digital presentation generation system breaks down data in the analytics application by different dimensions to generate digital data visualizations that describe variations within a dataset. In some embodiments, the dimension includes properties not inherently numerical such as geographic location, time periods, product categories (e.g., clothes, shoes, books, computers, etc.), user groups, and demographics (e.g., gender, age, income level).

In one or more embodiments, a “metric” refers to a quantifiable attribute or characteristic that assigns a number to digital events (e.g., dimensions). In particular, the digital presentation generation system utilizes a metric in tandem with dimensions to provide evaluation and comparison between different dimensions. For example, the metric refers to inherently numerical properties such as total calls, an average call duration, page views, unique visitors, bounce rate, conversion rate, add to cart percentage, feedback scores, shares, comments, and clicks.

In one or more embodiments, a “value” refers to specific quantitative or qualitative results that correspond to the dimensions or metrics. For example, the value include counts, percentages, and ratios. Specifically, the value includes total number of calls, revenue counts, conversion rates, the number of visits, satisfaction scores, etc.

In one or more embodiments, a “visualization” includes a data visualization that represents different types of data. For example, the visualization includes a line plot, a bar chart, a histogram, a pie chart, a scatter plot, a box plot, a heat map, a donut chart, a bubble chart, a Sankey diagram, and a network graph. In some embodiments, the digital presentation generation system uses “an intelligent captioning model” which refers to a model for generating insights and further includes a model for generating captions for the insights.

In one or more embodiments, an “insight” (e.g., a set of insights) refers to actionable and meaningful findings that are derived from analyzing the data extracted from an analytics application. In other words, the digital presentation generation system generates the set of insights that represent a deeper understanding of patterns, trends, relationships, or anomalies within the data (e.g., insights are more than just numbers and statistics, but interpretations of the numbers and statistics). In particular, the digital presentation generation system generates the set of insights from the data, where the set of insights is generated based on dimensions, metrics, values, and visualizations. Furthermore, in some embodiments, the digital presentation generation system generates captions that textually represent/describe the set of insights.

In one or more embodiments, the digital presentation generation system provides an option for a user to submit a user specified parameter. In particular, a “user specified parameter” refers to an option to configure a ranking of the set of insights. For example, the user specified parameter indicates specific dimension values of interest from the data extracted from the analytics application.

In one or more embodiments, the digital presentation generation system further performs insight grouping and ordering to create narrative grouping structures. In particular, a “narrative grouping structure” refers to the grouping of insights (e.g., from the set of insights or the subset of insights) into sections and how insights will be organized within digital slides of a digital presentation. For example, the digital presentation generation system generates the narrative grouping structures based on the visualizations, dimensions, metrics, and/or values of insights. In particular, the digital presentation generation system groups together insights that have the same/similar dimensions, metrics, and/or values (e.g., to reduce a number of repeated visualizations in a digital presentation).

In one or more embodiments, a “digital presentation” refers to a digital file that contains a series of slides or screens that combine text, images, graphics, audio, video, and animations to communicate a message (e.g., insights) to an audience. In other words, the digital presentation helps a presenter convey, engage, inform, and persuade an audience through a series of structured content. In particular, the digital presentation generation system generates a digital presentation from a digital presentation outline of the narrative grouping structures that contains various digital slides and sections within the digital presentation. In one or more implementations, a digital presentation comprises a slide show or deck of slides.

In one or more embodiments, the digital presentation generation system further provides a digital presentation prompting interface as part of the digital presentation. In particular, the “digital presentation prompting interface” refers to a sub-portion of a display window that is displayed side-by-side with the digital presentation and allows a presenter to submit prompts. For example, the digital presentation prompting interface allows a user to prompt the digital presentation generation system for updates to the digital presentation, comparisons, or to generate new slides to include in the digital presentation. In particular, in response to receiving a prompt from the digital presentation prompting interface, the digital presentation generation system pings the analytics application to either update, compare, or generate new slides.

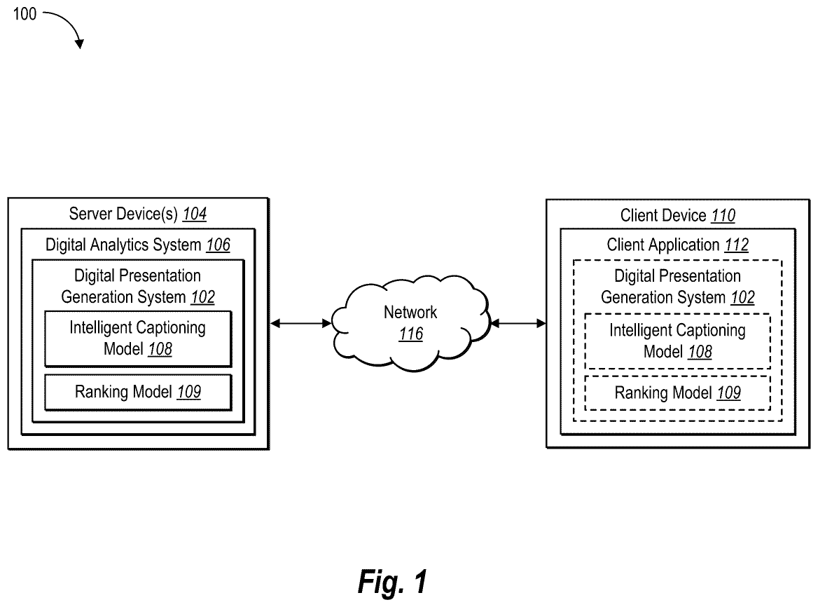

Additional details regarding the digital presentation generation system will now be provided with reference to the figures. For example, FIG. 1 illustrates a schematic diagram of an exemplary system environment 100 in which a digital presentation generation system 102 operates. As illustrated in FIG. 1, the system environment 100 includes server device(s) 104, a digital analytics system 106, a network 116, and a client device 110. Additionally, FIG. 1 illustrates that the digital analytics system 106 includes the digital presentation generation system 102, which includes an intelligent captioning model 108 and a ranking model 109. Moreover, the client device 110 includes a client application 112 (e.g., a client side digital application for digital analytics and digital presentations).

Although the system environment 100 of FIG. 1 is depicted as having a particular number of components, the system environment 100 is capable of having a different number of additional or alternative components (e.g., a different number of server devices, client devices, or other components in communication with the digital presentation generation system 102 via the network 116). Similarly, although FIG. 1 illustrates a particular arrangement of the server device(s) 104, the network 116, and the client device 110, various additional arrangements are possible.

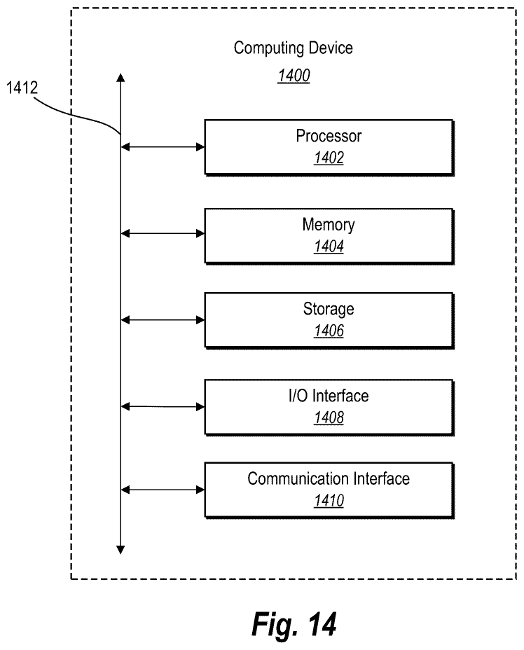

The server device(s) 104 and the client device 110 are communicatively coupled with each other either directly or indirectly (e.g., through the network 116 discussed in greater detail below in relation to FIG. 14). Moreover, the server device(s) 104 and the client device 110 include one or more of a variety of computing devices (including one or more computing devices as discussed in greater detail in relation to FIG. 14).

As mentioned above, the system environment 100 includes the server device(s) 104. In one or more embodiments, the server device(s) 104 process input data from the digital analytics system 106 that includes analytics data. In one or more embodiments, the server device(s) 104 comprise a data server. In some implementations, the server device(s) 104 comprise a communication server or a web-hosting server.

In some embodiments, the client device 110 is associated with the one or more user accounts that submit requests to generate inpainted digital images. In one or more embodiments, the client device 110 includes smartphones, tablets, desktop computers, laptop computers, head-mounted-display devices, or other electronic devices. The client device 110 includes one or more software applications (e.g., the client application 112) for generating or modifying digital presentations in accordance with the digital analytics system 106. In one or more embodiments, the client application 112 includes a software application hosted on the server device(s) 104 accessible by the client device 110 through another application, such as a web browser.

To provide an example implementation, in some embodiments, the digital analytics system 106 on the server device(s) 104 supports the client application 112 on the client device 110. For instance, in some cases, the digital presentation generation system 102 on the server device(s) 104 trains the intelligent captioning model 108 and/or the ranking model 109. In response, the digital presentation generation system 102, via the server device(s) 104, provides the trained intelligent captioning model 108 and/or the ranking model 109 to the client device 110. In other words, the client device 110 obtains (e.g., downloads) the intelligent captioning model 108 and/or the ranking model 109 from the server device(s) 104 that is already trained/optimized. Once downloaded, the intelligent captioning model 108 and/or the ranking model 109 on the client device 110 is able to perform tasks (e.g., generate insights, rank insights, generate narrative grouping structures, generate digital presentations) independent from the server device(s) 104. In one or more alternative implementations, the digital presentation generation system 102 generates or learns parameters for the intelligent captioning model 108 and/or the ranking model 109 in whole or in part on the client device 110.

In alternative implementations, the digital analytics system 106 includes a web hosting application that allows the client device 110 to interact with content and services hosted on the server device(s) 104. To illustrate, in one or more implementations, the client device 110 accesses a software application supported by the server device(s) 104. In response, the digital analytics system 106 on the server device(s) 104 provides tools for submitting user specified parameters and submitting prompts to generate digital presentations. In other words, the client device 110 does not have to download the digital presentation generation system 102 or intelligent captioning model 108 and/or the ranking model 109 while still being able to access/utilize the trained/optimized tools provided by the digital analytics system 106 via a web hosting application.

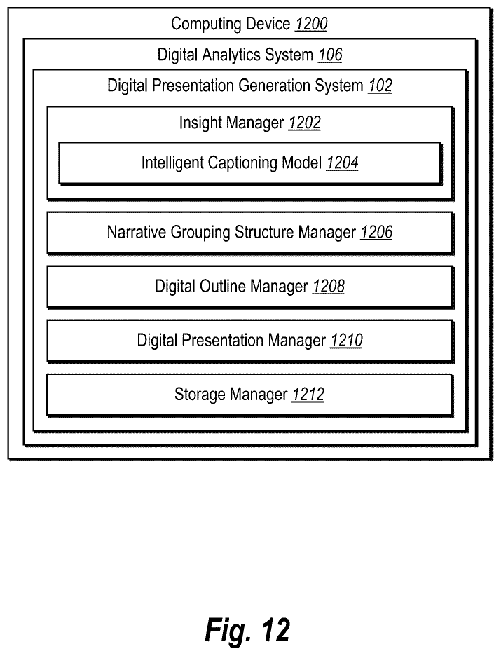

In some embodiments, the digital presentation generation system 102 is implemented in whole, or in part, by the individual elements of the system environment 100. For instance, although FIG. 1 illustrates the digital presentation generation system 102 implemented or hosted on the server device(s) 104, different components of the digital presentation generation system 102 are able to be implemented by a variety of devices within the system environment 100. For example, one or more (or all) components of the digital presentation generation system 102 are implemented by a different computing device or a separate server from the server device(s) 104. Indeed, as shown in FIG. 1, the client device 110 includes the digital presentation generation system 102. Example components of the digital presentation generation system 102 will be described below with regard to FIG. 12.

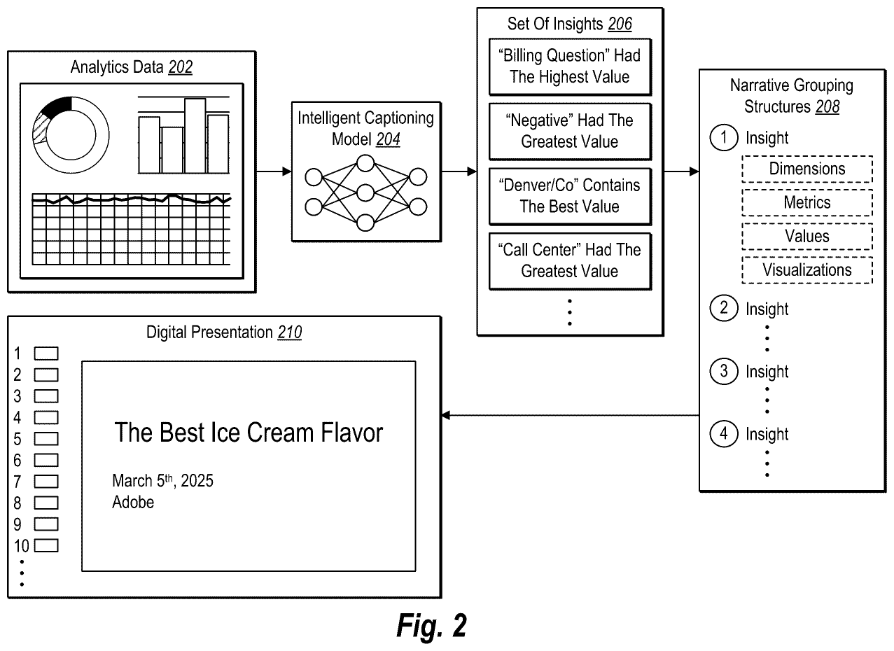

As mentioned above, in certain embodiments, the digital presentation generation system 102 generates a digital presentation from a set of insights. FIG. 2 illustrates the digital presentation generation system 102 using an intelligent captioning model to generate insights, generating narrative grouping structures from the insights, and generating a digital presentation from the narrative grouping structures in accordance with one or more embodiments.

As mentioned above, the digital presentation generation system 102 extracts analytics data 202 from an analytics application. In some embodiments, the digital presentation generation system 102 accesses an analytics application (e.g., an analytics dashboard) that contains multiple visualizations and/or data tables that are intentionally arranged to provide an overview and details about a larger, complex dataset. In particular, the digital presentation generation system 102 converts the analytics data 202 in the analytics application to a file (e.g., a JSON file) that indicates the visualizations and relevant metadata (e.g., chart type, row/column position in the dashboard, metrics, values, dimensions) and uses it as input to an intelligent captioning model 204.

In one or more embodiments, an analytics application refers to a software platform to collect, process, analyze, and visualize data. In particular, the analytics application provides tools for a user to monitor and optimize metrics (e.g., website traffic, user engagement, and conversions). For example, the analytics application provides tools to visualize certain trends in the data. In some embodiments, the digital presentation generation system 102 uses the analytics application to perform data collection, perform data integration (e.g., obtain data from multiple sources), provide analytics of collected data, perform segmentation of the data (e.g., filter the data based on certain attributes), and analyze/visualize the data based on metrics and dimensions.

In some embodiments, the digital presentation generation system 102 uses the analytics application to store digital events collected for analysis. For example, the analytics application stores and handles large volumes of digital data generated from various digital sources. Further, in some embodiments, the digital presentation generation system 102 queries the analytics application to obtain one or more digital events (e.g., dimensions, metrics, values, visualizations) stored within the analytics application.

As mentioned above, the digital presentation generation system 102 further generates a set of insights 206 from the data. In some embodiments, the digital presentation generation system 102 uses the intelligent captioning model 204 to generate insights that contain metadata (e.g., content of an insight, such as the particular values that are being mentioned to determine the insights) such as the insight type and the particular dimension values described in the insight.

In some embodiments, the digital presentation generation system 102 uses the intelligent captioning model 204 to generate insights for charts based on chart types (e.g., visualizations). In particular, the digital presentation generation system 102 uses the intelligent captioning model 204 to define a set of insight types (e.g., greatest value, highest value, lowest value, average value, greatest increase, greatest decrease, and time range) for each chart type that aligns with analytical objects in visualizing charts.

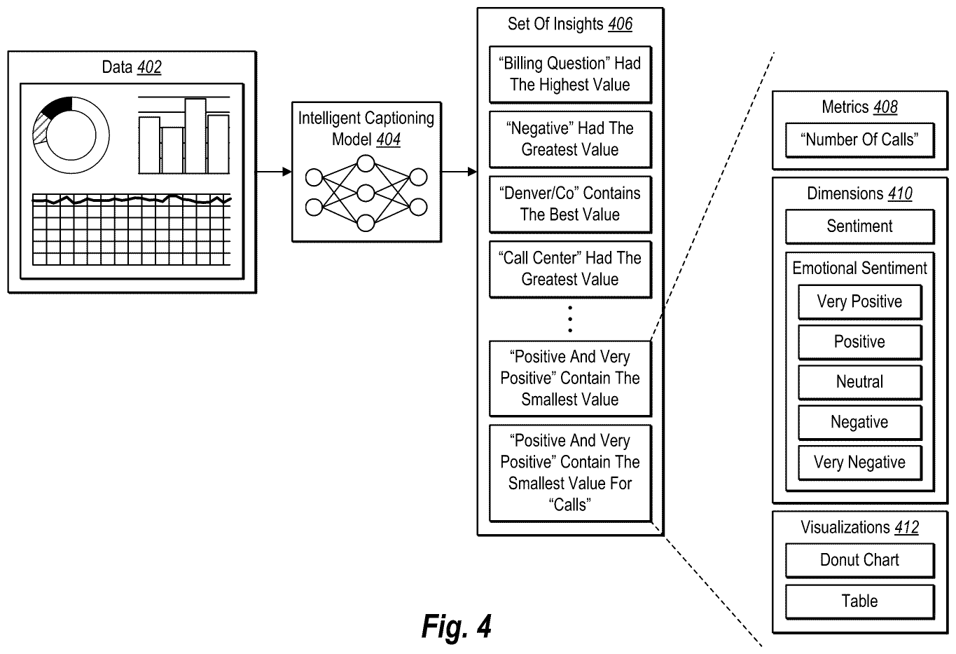

To illustrate, FIG. 2 shows the digital presentation generation system 102 generating the set of insights 206 that includes 1) “billing question” had the highest value, 2) “negative” had the greatest value, 3) “Denver/CO” contains the best value, and 4) “call center” had the greatest value. In particular, the digital presentation generation system 102 interprets the analytics data 202 and generates the set of insights 206 based on the interpreted analytics data. Additional details of the intelligent captioning model 204 are provided below in the description of FIG. 4.

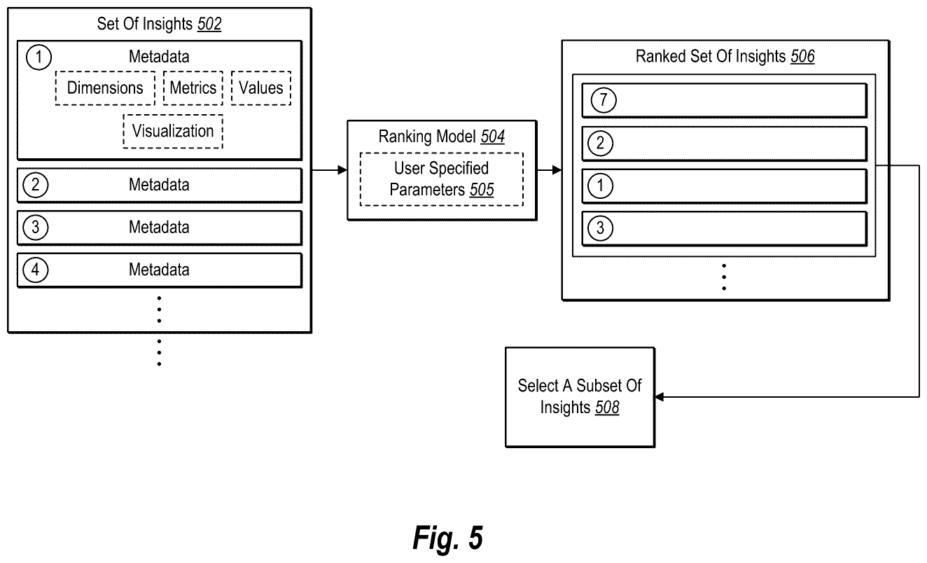

Moreover, in some embodiments, the digital presentation generation system 102 performs a ranking of the generated insights based on the metadata for the insight. In particular, the digital presentation generation system 102 performs the ranking based on the position of a visualization in a dashboard and a frequency of referenced dimension values in an insight. Additional details of using a ranking model are provided below in the description of FIG. 5.

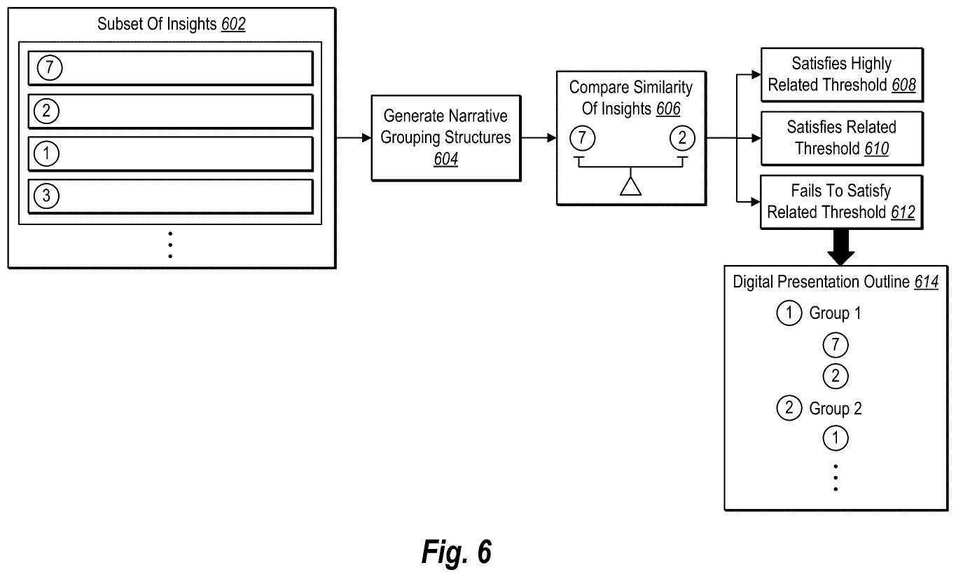

Moreover, as shown in FIG. 2, the digital presentation generation system 102 generates narrative grouping structures 208 from the set of insights 206. As mentioned above, the digital presentation generation system 102 creates an overall narrative structure of the set of insights 206 based on similarities between the set of insights 206. Thus, as shown in FIG. 2, the narrative grouping structures 208 contains an ordered set of insights and the associated metadata (e.g., at least one of the dimensions, the metrics, the values, and the visualizations). Additional details of the narrative grouping structures 208 is given below in the description of FIG. 6.

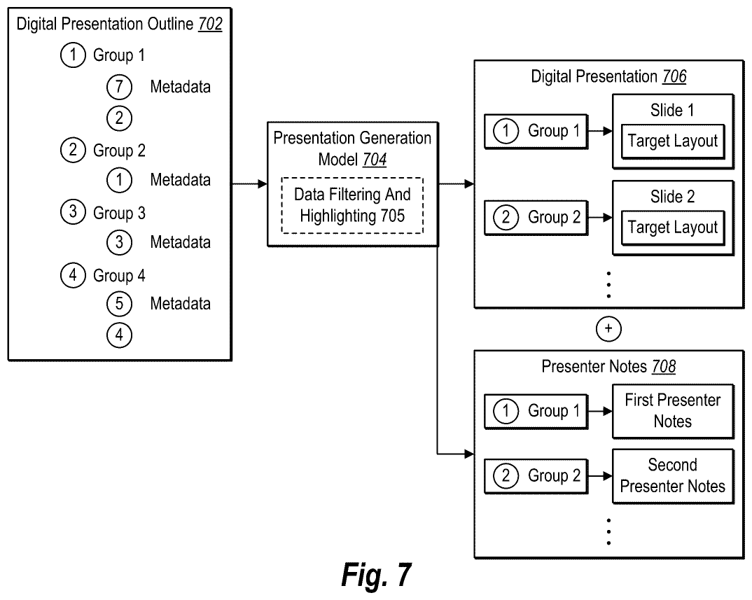

As mentioned above, the digital presentation generation system 102 converts the narrative grouping structures 208 to a digital presentation 210. In particular, the digital presentation generation system 102 converts a digital presentation outline of the narrative grouping structures 208 into the digital presentation 210 with an appropriate theme, context, and layout that matches the content of the digital presentation outline (e.g., the data of the insights). In some embodiments, the digital presentation generation system 102 performs the steps shown in FIG. 2 in response to user input (e.g., selecting a graphical user interface element to download data from the analytics dashboard into the digital presentation 210) Additional details of generating the digital presentation 210 is given below in the description of FIG. 7.

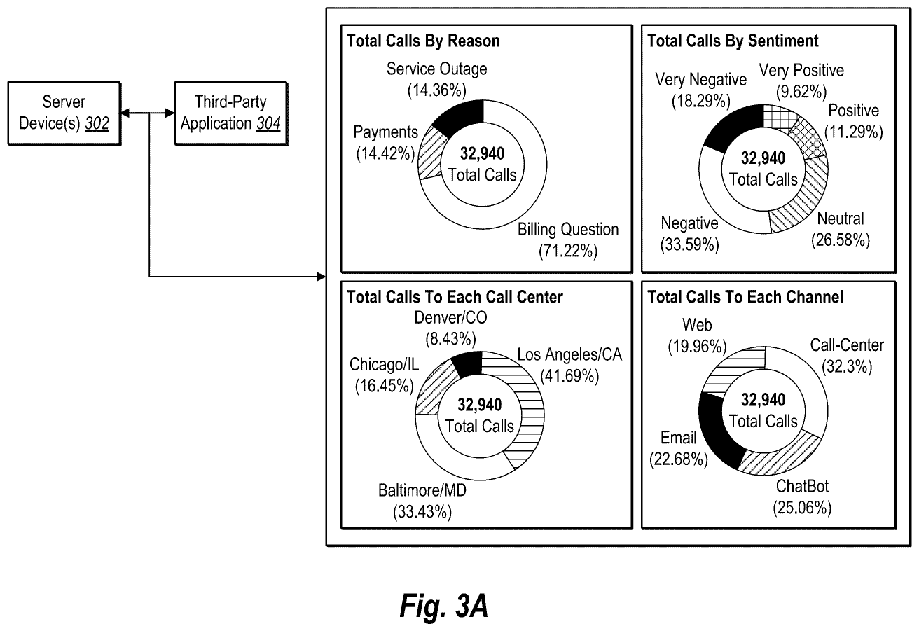

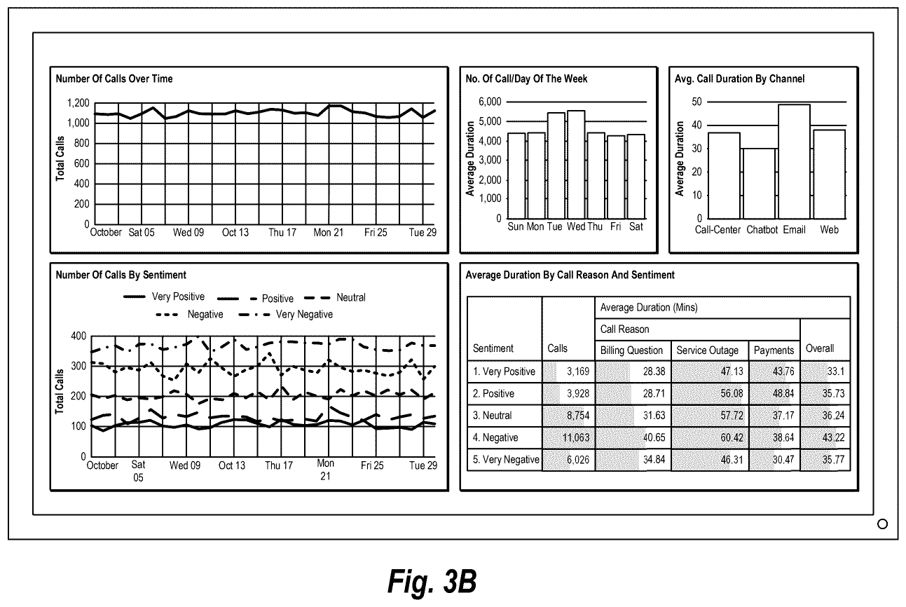

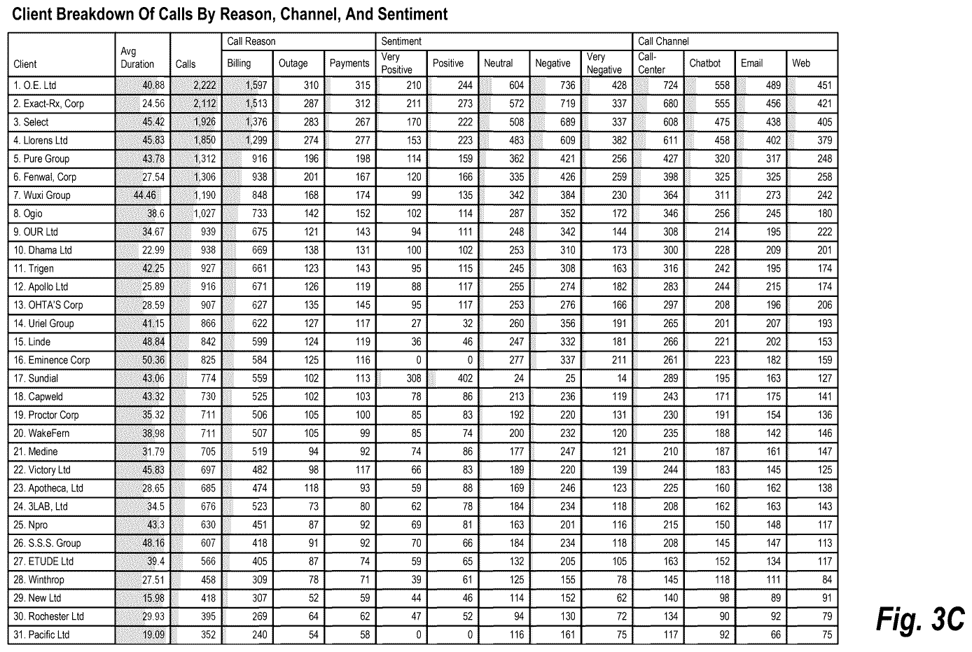

As mentioned above, the digital analytics system 106 generates an analytics dashboard from analytics data. For example, FIGS. 3A-3C illustrate an analytics dashboard in an analytics application in accordance with one or more embodiments. In one or more embodiments, an analytics dashboard refers to a visual interface that consolidates and presents data in a single graphical user interface. In particular, an analytics dashboard includes graphs, charts, tables, and other visual elements that convey data to an analyst about certain trends in the data. In some embodiments, the analytics dashboard is updated in real-time based on additional data/updates to existing data. Further, in some embodiments, the digital analytics system 106 provides various tools for customizing an analytics dashboard (e.g., determining which chart visualizations to display and where to place certain visualizations). Additionally, in some embodiments, the digital analytics system 106 allows an analyst to dig deeper into certain portions of the analytics dashboard (e.g., display more granular data).

Moreover, in some embodiments, the digital analytics system 106 displays more important information at the top of the analytics dashboard and less important information at the bottom of the analytics dashboard. In some embodiments, where an analyst customizes the analytics dashboard, the digital presentation generation system 102 analyzes the customized dashboard to determine a hierarchy of importance (e.g., a hierarchy of importance from the analyst's viewpoint).

As shown in FIG. 3A, the digital analytics system 106 utilizes server device(s) 302 to monitor a third-party application 304 (e.g., to obtain analytics data). In particular, the digital presentation analytics system 106 utilizes a variety of monitoring and integration techniques to gather data, such as API (application programming interface) integrations, webhooks, file monitoring, embedded analytics, and database access.

In some embodiments, for API integration, the digital presentation generation system 102 uses the server device(s) 302 to send API requests to retrieve data from the third-party application 304. Further, for webhooks, the third-party application 304 pushes data to the server device(s) 302 in real-time when certain events occur. Moreover, for file monitoring, the third-party application 304 generates file logs that contain detailed information about operations and the digital presentation generation system 102 uses the server device(s) to monitor the file logs. In addition, for embedded analytics, the digital presentation generation system 102 uses the server device(s) 302 which directly integrates with the third-party application 304 to directly collect data from the third-party application 304. Moreover, for database access, the digital presentation generation system 102 uses the server device(s) 302 to directly access a database where the third-party application stores data.

As shown in FIG. 3A, the digital analytics system 106 generates an analytics dashboard that contains multiple donut charts. In particular, the donut charts (e.g., from top left to right and bottom left to right) portray metrics of “total calls by reason,” “total calls by sentiment,” “total calls to each call center,” and “total calls to each channel.” Further, for “total calls by reason” the donut chart shows the dimensions of “service outrage” (e.g., with value of 14.36%), “payments” (e.g., with value of 14.42%), and “billing question” (e.g., with value of 71.22%).

Moreover, for “total calls by sentiment” the donut chart shows the dimensions of “very negative” (e.g., with value of 18.29%), “very positive” (e.g., with value of 9.62%), “positive” (e.g., with value of 11.29%), “neutral” (e.g., with value of 26.58%), and “negative” (e.g., with value of 33.59%). Likewise, the rest of the donut charts also show various dimensions and values associated with those dimensions.

Furthermore, FIG. 3B shows additional portions of the analytics dashboard. In particular, FIG. 3B shows multiple line graphs, bar graphs, and a table. For example, FIG. 3B shows a line graph for the metric of “number of calls by sentiment” that is broken down into the dimensions of “very positive,” “positive,” “neutral,” “negative,” and “very negative.” In addition, FIG. 3B shows for example, a bar graph with dimensions spanning each day of the week for a metric of “average duration” of the call. Moreover, FIG. 3B shows the table that is for the “average duration by call reason and sentiment” where the table is broken down with dimensions for different sentiments and call reasons.

Moreover, FIG. 3C shows a table of client breakdown of calls by reason, channel, and sentiment. In particular, FIG. 3C show a detailed and granular table broken down by the dimensions of different clients, where each of the different clients has a value for average duration, the number of calls, the call reason, the sentiment, and the call channel. FIGS. 3A-3C illustrates the digital presentation generation system 102 generating an analytics dashboard with a complex amount of data that starts at the top with simpler visualizations and the visualizations become more complex as one moves down the analytics dashboard. As highlighted above, even from the large amounts of data and complex visualizations, the digital presentation generation system 102 effectively generates insights from the analytics dashboard and further generates a digital presentation from the insights.

As mentioned above, the digital presentation generation system 102 uses an intelligent captioning model to generate a set of insights. For example, FIG. 4 illustrates the digital presentation generation system 102 generating a set of insights that further include metadata for each of the insights in accordance with one or more embodiments. FIG. 4 shows the digital presentation generation system 102 accessing data 402 extracted from an analytics application and using an intelligent captioning model 404 to generate a set of insights 406. In particular, the digital presentation generation system 102 generates the set of insights 406 that include 1) “billing questions” had the highest value, 2) “negative” had the greatest value, 3) “Denver/CO” contains the best value, 4) “call center” had the greatest value, 5) “positive and very positive” contain the smallest value, and 6) “positive and very positive” contain the smallest value for calls.

As shown in FIG. 4, insights of the set of insights 406 are associated with metadata. In particular, an insight from the set of insights 406 includes metrics 408, dimensions 410, and visualizations 412. To illustrate, for a metric of “number of calls” the analytics application has a dimension of “sentiment” where the dimension “sentiment” is further broken down into dimensions (e.g., sub-dimensions) such as “very negative,” “negative,” “neutral,” “positive,” and “very positive.” To further illustrate, for a metric of “total calls to each call center” the analytics application has a dimension of “call center” and further breaks down “call center” into dimensions such as “Denver/CO,” “Chicago/IL,” “Baltimore/MD,” and “Los Angeles/CA.”

To illustrate, in the context of “call center data” the analytics application uses a metric of “number of calls” for different dimensions such as “reason,” “sentiment,” “call center,” “channel,” “time,” and “average call duration by channel.” In some embodiments, the metric “total calls” has a value of “32,940.” Further, in some embodiments, the metric “total calls” is further broken down by the dimension “sentiment” such that “very negative” has a value of “6,026,” “negative” with a value of “11,063,” “neutral” with a value of “8,754,” “positive” with a value of “3,928,” and “very positive” with a value of “3,169” In other words, the digital presentation generation system 102 utilizes the value to create a digital data visualization (e.g., a donut table, a bar chart, a line chart, etc.), where the value corresponds to a specific analytics database (e.g., call center data).

FIG. 4 generally shows the digital presentation generation system 102 generating the set of insights 406 from the data 402 using the intelligent captioning model 404. In some embodiments, the digital presentation generation system 102 uses a machine learning model as the intelligent captioning model 404.

In one or more embodiments a machine learning model includes a computer algorithm or a collection of computer algorithms that is trained and/or tuned based on inputs to approximate unknown functions. For example, a machine learning model includes a computer algorithm with branches, weights, or parameters that changed based on training data to improve for a particular task. Thus, a machine learning model utilizes one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

The following description provides additional examples and details of how the digital presentation generation system 102 uses the intelligent captioning model 404. In some embodiments, the digital presentation generation system 102 defines a rule set for each insight type that provides executable instructions for obtaining insight data for each insight type. In particular, the digital presentation generation system 102 uses the intelligent captioning model 404 to analyze insight data from the data 402, which includes data items (e.g., dimensions, metrics, and values) extracted from underlying chart data for charts.

In some embodiments, a rule in a rule set instructs the intelligent captioning model 404 to obtain an attribute name (e.g., a metric or a dimension), attribute value, or other data item occurring in the chart data. In some embodiments, a rule in a rule set instructs the intelligent captioning model 404 to compute a data item based on the chart data using any of various computation methods such as, for instance, statistics calculation, anomaly detection, seasonality detection, comparison analysis, correlation analysis, and flow aggregation (e.g., tailored for Sankey charts).

In some embodiments, the digital presentation generation system 102 feeds as input to the intelligent captioning model 404 a chart (e.g., a visualization) that includes a chart type and the underlying chart data associated with the chart. In particular, the chart type identifies the type of visualization used by the chart, such as, for instance, a line chart, an area chart, a bar chart, a donut chart, a histogram, a fallout visualization, or a Sankey diagram. Moreover, the chart data includes the attribute names and the attribute values from the structured data used to generate the chart.

In some embodiments, the input also includes configuration data that provides additional parameters for generating the insights. In particular, the configuration data indicates, for instance, the language for the generated caption, whether the data contains multiple series, or whether to include insights comparing the chart data from one time period with chart data from another time period (e.g., current chart data compared with previous chart data).

In one or more embodiments, given input data for a chart identifying a chart type and providing chart data, the digital presentation generation system 102 utilizes the intelligent captioning model 404 to generate insights for the insight types defined for the chart type identified in the input data. In particular, the digital presentation generation system 102 utilizes the intelligent captioning model 404 access the rule set defined for each insight type defined for the chart type to extract insight data for each insight type based on the chart data. For example, the digital presentation generation system 102 utilizes the intelligent captioning model 404 to extract insight data that includes obtaining data items occurring in the chart data and/or computing data items based on the chart data.

To illustrate, suppose input data is received for a line chart showing the number of daily orders over a time period, and a minimum insight is generated from the input data. Given this input data, the digital presentation generation system 102 utilizes the intelligent captioning model 404 to generate insight data with the following data items: the metric “orders”, the minimum number of orders, the date on which that occurred, the average daily orders during that time period, and how much lower the minimum number is than the average daily orders.

In instances in which the input data includes other configuration data, the digital presentation generation system 102 utilizes the intelligent captioning model 404 to generate insight values in alignment with that configuration data. For instance, if the input data sets a comparison field as true and includes comparison data, the digital presentation generation system 102 utilizes the intelligent captioning model 404 to generate a comparison insight based on a comparison of the subject data and the comparison data. Moreover, in some embodiments, the digital presentation generation system 102 utilizes the intelligent captioning model 404 to generate captions for the insights. In particular, each caption includes natural language text that includes insight data generated for a given insight.

To illustrate, for the call center data, the digital presentation generation system 102 uses the intelligent captioning model to generate a caption for an insight (e.g., for a donut chart of total calls by sentiment) such as, “positive and very positive” (e.g., the sentiments) contain “the smallest values with around 3548.5 calls or 22% in total of the calls.” Further, the digital presentation generation system 102 uses the intelligent captioning model to generate an insight of “negative” sentiment had the greatest sentiment for “total calls by sentiment.” To further illustrate, for “ice cream data,” the digital presentation generation system 102 uses the intelligent captioning model 404 to generate a caption for an insight such as “the max attribute, honey salted caramel almond, is 2% more than the second highest one, chocolate and nuts, in average rating” or “coffee chip had the greatest decrease in average rating.”

In some embodiments, the digital presentation generation system 102 utilizes the intelligent captioning model 404, which employs a template-based approach to generate captions. For each insight type, a pre-defined template is stored that includes natural language text with placeholders for data items from the insight data for the insight. In such configurations, when the intelligent captioning model 404 receives the insight data for a given insight, the digital presentation generation system 102 utilizes the intelligent captioning model 404 to generate a caption for the insight by retrieving the template for the insight type of the insight and replacing the placeholders in the template with data items from the received insight data. In some embodiments, each template includes natural language text with placeholders for insight data. In particular, multiple template options are provided for a given insight type with various levels of conciseness and formality, thereby allowing for the generation of diverse captions.

In some embodiments, the digital presentation generation system 102 employs a generative model as the intelligent captioning model 404 to facilitate generation of natural language text for captions. For instance, a prompt could be generated that includes insight data provided by the intelligent captioning model. In particular, the prompt includes information instructing the generative model how to generate the caption, such as information indicating the type or style of language to use to describe the insight data based on the insight type of the insight.

In some embodiments, the prompt is provided as input to the generative model, which generates natural language text that includes the insight data. The generative model includes a language model that includes a set of statistical or probabilistic functions to perform Natural Language Processing (NLP) in order to understand, learn, and/or generate human natural language content. For example, the digital presentation generation system 102 uses a language model as a tool that determines the probability of a given sequence of words occurring in a sentence or natural language sequence.

Simply put, the digital presentation generation system 102 uses a model that is trained to predict the next word in a sentence. A language model is called a large language model (LLM) when it is trained on an enormous amount of data (e.g., a threshold amount of data) and/or has a large number of parameters. Some examples of LLMs are Adobe Assistant AI, and GPT-based models. These models have capabilities ranging from writing a simple essay to generating complex computer codes-all with limited to no supervision. Accordingly, an LLM includes a deep neural network that is very large (billions to hundreds of billions of parameters) and understands, processes, and produces human natural language by being trained on massive amounts of text. These models predict future words in a sentence letting them generate sentences similar to how humans talk and write or otherwise in a form dictated, for instance, by a prompt.

The following provides examples of insight types for various chart types, including a discussion of methodologies employed for extracting insight data, determining significance, and generating example captions. It should be understood that the insight types and chart types described below are provided for illustration purposes only. Aspects of the technology described herein provide an extensible framework for extracting insights and generating captions for any insight type and any chart type.

For single line charts and area charts, one data format for a line chart includes a temporal field paired with a numerical field, resulting in a singular line chart. An area chart, a visual alternative to the line chart, features filled colors or other visual representations that convey the same data structure. As a result, in some embodiments, the digital presentation generation system 102 use the same insight types for line charts and area charts. Line charts are frequently employed to understand the temporal dynamics of data. As such, the insight analysis in some configurations is based on statistically significant data points or notable changes along the temporal axis. In particular, the insights for line charts include maximum insights, minimum insights, spike insights, decline insights, seasonality insights, trend insights, and anomaly insights.

Maximum and minimum insights provide context on the overall statistics of the data, encompassing the data average. They highlight the extent to which maximum and minimum data points deviate from this average. The significance of this insight is appreciated by considering the degree to which the maximum data point exceeds the average or the minimum data point falls below the average. Example captions for minimum and maximum insights for a line chart are: [Min] The lowest number of orders of 94,402 appeared on February 21st, 20% less than the average of 117,700. [Max] Throughout this period, the number of orders topped 159,484 on February 8th. It was 36% more than the average.

Spike and decline insights identify instances of a substantial increase or decrease in values, indicating a noteworthy rate of change. To ascertain the significance of these spikes or declines, the change rate for each time step is calculated and the z-score is employed as a metric to represent their importance. Example captions for spike and decline insights for a line chart are provided below: [Spike] The number of orders grew significantly between February 7th and 8th, up by 32% from 120,958 to 159,484. [Decline] During the period of February 20th to 21st, the number of orders declined significantly, falling by 35% from 145,528 to 94,402.

Seasonality insights pinpoint cyclic patterns indicative of regular temporal dynamics. In the realm of business and digital marketing, for instance, recognizing these patterns assists users in observing operational key performance indicators (KPIs) and campaign performances. In some embodiments, to detect potential cyclic patterns, temporal correlation is employed, calculating the correlation coefficient between the time-series and a delayed copy of it across various time windows (e.g., ranging from one hour to one year). A time series is deemed to exhibit a valid cyclic pattern if the coefficient surpasses a predefined threshold. The significance of the cyclic pattern is then conveyed through the magnitude of the coefficient. An example caption for a seasonality insight for a line chart is provided below: [Seasonality] There was a weekly cyclic pattern in the number of orders. For each week, the peak number occurred at around the 2nd day and the valley occurred at around the 3rd day.

Trend and anomaly insights focus on detecting both level changes in the line and irregular data points within the overall trend. In contrast to spike and decline insights, which only account for continuous increases or decreases, trend insights provide a broader perspective on the value's overall increase or decrease, disregarding temporary reversals. To do so, a time-series decomposition algorithm is employed, which decomposes a time-series into three components: yₜ=Sₜ+Tₜ+Iₜ+e, where yₜ is the original data, Sₜ is the seasonal component, Tₜ is the trend component, Iₜ is the irregular component, and e represents the fitting error. The trend and anomaly insights are derived from the trend and irregular components, respectively. The significance of these insights is gauged by the normalized value of the fitting error. Example captions for trend and anomaly insights for a line chart are: [Trend] Throughout this period, there was a downward trend from Oct. 13, 2020, to Oct. 29, 2020 at a rate of −36,798 less visits per time-step, going down from 11,974,677 to 11,385,900. [Anomaly] 2 anomalous number of visits were detected on Oct. 13, 2020, and Oct. 29, 2020. On average, the number of visits on these dates deviated by 67% from expectation.

In addition to the single line charts, multi-line charts featuring time series with distinct categorical labels are often used. Multi-line charts provide for comparing various time series to discern their similarities and differences. For instance, a multi-line chart is used to compare revenues across different product categories to formulate a campaign strategy or analyze the correlation between email engagement and purchases as an indicator of campaign performance. Consequently, when generating captions for multi-line charts, some aspects generate comparative insights, accentuating the most notable series within the group. The approach involves individual analysis of each time series to extract insights, with subsequent emphasis on the one exhibiting the highest significance value. The insights for multi-line charts includes maximum insights, minimum insights, spike insights, decline insights, seasonality insights, trend insights, anomaly insights, and correlation insights.

In some embodiments, Maximum and Minimum insights highlight the time series with the highest maximum value and the lowest minimum value among all: [Max] Visits has the highest maximum value, 72,800,865, which occurred on June 7th and was 35% higher than its average 53,859,108. [Min] Labs Prototype Exits has the most notable minimum value 0 occurred on May 6th, which is 100% less than the average of 7.

In some embodiments, spike and decline insights identify the series that exhibits the most significant changes among all: [Spike] The greatest increase occurred in Revenue between June 3rd and 7th, growing by 1,019% from 2,109,546.31 to 23,601,840.9. [Decline] The greatest decrease appeared in Revenue from June 7th and 10th, 92% from 23,601,840.9 to 1,937,437.79.

In some embodiments, seasonality insight identifies the most noteworthy cyclic pattern observed across all-time series: [Seasonality] Visits exhibits the most significant cyclic pattern occurring every 7 days with the peak typically appearing on day 6 and valley on day 3.

In some embodiments, a trend insight identifies the most significant trend observed among all time series: [Trend] The most significant trend is observed in Visits from November 10th to December 2nd, with an increment of 65,015 per time-step on average, going from 131,750 to 1,562,080.

In some embodiments, an anomaly insight focuses on the series that displays the highest count of anomalous data points and the series with anomalous data points deviating the most from the average: [Anomaly] Visits has the largest number of 6 anomalies observed, where the values deviated by 83% from the period average. Revenue has most significant anomaly observed on June 29, deviating from expected value by +144%.

In some embodiments, a correlation insight assesses the similarity in trends among time series. In some embodiments, the Pearson correlation coefficient is computed for each pair of time series, retaining those with a coefficient exceeding a specified threshold. The caption is designed to highlight the most correlated pair of time series, while also providing context on the correlations within the remaining pairs: [Correlation] Visits and Orders exhibits strongest pair-wise correlation, while no correlation was found in other metric pairs.

For time comparison for line charts and area charts, beyond scrutinizing time series within a single time range, the comparison of data across distinct time periods is often analyzed. Consequently, in some embodiments, the digital presentation generation system 102 integrates an additional field in the input data, accommodating information from a second time range and facilitating the generation of comparative insights between the primary and secondary time ranges. Within this context, each insight generated is accompanied by a comparative insight illustrating the distinctions between the current time range and the comparison time range, as illustrated by the following examples: [Min] The lowest number of orders of 2,047 appeared on 00:00 August 9th 56% less than the average of 4,676. Compared to the previous period, there is a 614 decrease by 30%. [Max] During this period the number of orders peaked 8,796 on 15:00 August 8th. The highest number of Workspace Project Loads was 88% more than the average. In comparison to the previous period, there is a reduction of 428 by 4.9%. [Spike] The amount of orders significantly increased in the span between 10:00 and 15:00 August 8th, growing by 90% from 4,627 to 8,796. The previous period exhibits a smaller increase, from 4,975 to 9,224 by 85%. [Decline] During the period of 14:00 to 00:00 August 9th the amount of orders declined significantly, falling by 77% from 8,796 to 2,047. In the previous interval, the decrease was smaller, from 9,224 to 2,261 by 75%.

In some embodiments, the digital presentation generation system 102 generates comparative insights within the above four categories, as these categories are linked to specific timestamped data values, enabling a more meaningful comparison with values from related timestamps. In contrast, insights related to seasonality, trend, and anomaly are less amenable to point-to-point comparisons, because these insights often encapsulate broader patterns and deviations over extended periods, making direct timestamp-to-timestamp comparisons less meaningful.

In addition to the general insight types, in some embodiments, the digital presentation generation system 102 generates comparison insight on the overall gain or loss: [Total] Compared to the data from August 1st, there is 8,213 (6.8%) decrease in the total number of orders.

Bar charts and donut charts both involve a categorical field paired with a numerical field. These visualizations are often employed to gain insights into the distribution of values across different categories. Bar charts emphasize the absolute values of distinct categories, while donut charts prioritize the proportional representation of values. Consequently, when crafting captions for bar and donut charts, the insights identify statistically significant categories, such as major and rare occurrences, or highlight notable distribution patterns, such as skewness and long-tail distributions.

Following the descending sorting of categories by metric values in bar and donut charts, the following insights are extracted: Max and Max Extent insights provide information about categories with the highest values. While emphasizing the highest value is useful, the highest category is not always significantly larger than others. Consequently, the max extent insight offers information about the degree to which the highest category surpasses the second highest. For categories that are not significantly higher than the second one, analysts refer to the max insight for more details about groups of categories with similarly high values. The digital presentation generation system 102 utilizes the intelligent captioning model 404 to facilitate the creation of such groups by initially clustering categories based on their values. Captions are then generated accordingly. In some embodiments, the complete-linkage criterion is employed to accomplish clustering in the one-dimensional distribution. [Max Extent] The max attribute, Table of Contents, is 3% more than the second highest one. [Max] Table of Contents, Annotations, Insight Generator, Dark Mode, Workspace Project PowerPoint Export and Intelligent Pathing contain the highest values, with around 248 in Occurrence (51% in total).

Skewness and long tail insights offer information regarding distribution anomalies in both bar and donut charts. Skewness points to instances where certain bars significantly surpass others in the distribution. Meanwhile, a long tail suggests the presence of numerous categories with relatively small values. To identify outliers, the z-score is used, determining the degree of an outlier in values. Subsequently, captions are generated based on small groups of high-value categories and large groups of low-value categories that surpass an established outlier threshold. [Skewness] The values of Lab Prototype Launches are highly skewed towards FreeformReportlet and LineReportlet (58% in total). [Long Tail Distribution] There are 21 attributes with Lab Prototype Launches less than or equal to 4,237.5 that form a tail distribution, which combined represent 42% in total.

Biggest Gain and Loss insights offer comparative analysis with respect to the preceding period. Comparable to the time-based comparisons in a line chart, the system enables inputting an additional series of values from the previous period, facilitating a thorough comparison between two bar or donut charts. [Biggest Gain] My Account: Purchase History has the most increase of 25% compared to previous period. [Biggest Loss] Checkout: Payment has the most decrease of 20% compared to previous period.

Histograms share a visual resemblance with a bar chart, a histogram is distinct in its representation of the distribution over continuous data, where values fall within specific intervals or ranges. The seamless continuity between bars in a histogram permits merging them, enabling the derivation of more consolidated insights based on value ranges. This shift in focus moves away from identifying individual standout bars, such as “Call Survey Score, 8, having the highest value in Sessions,” toward summarizing the distribution in a more condensed manner through grouping the bars by their similarity in value. For instance, one could convey that “Over 90% of the sessions exhibit Call Survey Scores ranging from 1 to 9”, given the similar number of sessions rating 1 to 9.

Given the distinctive analytical objective of a histogram, in some embodiments, the digital presentation generation system 102 employs order-preserving hierarchical clustering to form clusters of bars. This approach recursively partitions the x-axis values based on their similarity in terms of y-axis values. The aim is to minimize value differences within each cluster while maximizing the differences in average values between clusters. This methodology enhances the distinction between groups, contributing to a more effective representation of the underlying data distribution. Through the clustering of bars, the following types of insights are provided.

Major Values: This insight refers to the cluster of bars characterized by the highest average value, providing a representation of the central tendency within the distribution: [Majority] Most sessions (99.6%) exhibit Call Survey Scores between 1 and 9 with an average of 5. Each Call Survey Scores has an average of 2181 sessions.

Rare Values: This insight pertains to the cluster of bars constituting less than 10% (subject to change) of the total, signifying the tail end of the distribution: [Rare Value] Only 79 (0.4%) Sessions has 10+ Call Survey Score.

Fallout visualizations are commonly used to visually represent the sequential steps or stages, commonly known as checkpoints, in a process, along with the success rate at each checkpoint. To create this visualization, analysts typically need to specify a list of checkpoints in a predetermined sequential order before generating the flow.

One analytical goal is to understand the overall flow of events or interactions, pinpointing checkpoints where drop-offs or failures occur in the progression. This visualization technique finds application in diverse fields such as, for instance, marketing, user experience design, and product analytics. It provides insights into user behavior and enables recognition of areas of friction or disengagement, allowing for informed, data-driven decisions to optimize the overall user journey. Given the above analytical goals, the following insights are extracted for fallout visualizations.

Max Fallout: This insight refers to the checkpoint demonstrating the most substantial drop-offs, highlighting a potential bottleneck within the entire process: [Max Fallout] The largest number of sessions fall out between Web Purchase Step 2 and Call, with 35, 408 sessions drop off and the highest dropout rate of 78%.

Flow Depth: This insight provides an overview of the pass-through rate across various checkpoints. In this context, the digital presentation generation system 102 applies a similar order-preserving clustering approach as employed in the analysis of histograms. This method helps identify key cut-off checkpoints, such as those experiencing relatively high drop-offs, allowing for summarizing the pass-through rates based on these identified critical points.

[Flow Depth] 73.4% of the sessions reached Step 2, while 16.1% of the sessions reached Step 3.

Apart from analyzing fallout in a single series, in some embodiments, the digital presentation generation system 102 also facilitates the analysis of fallout visualizations with multiple series. In this context, the emphasis is on incorporating a comparative analysis of flow across different categories. Specifically, the following insights are extracted for the multiple series fallout visualizations.

Max Fallout—All: Similar to the analysis of individual series fallout, this insight offers an overall view of general flow patterns by aggregating the fallout flow under different categories: [Max Fallout—All] The largest drop out appears between Login and Analyze, involving 70,265 people and a dropout rate of 40.2%. The largest dropout rate occurs between Collaborate and Act, with 20,821 people fall out and a dropout rate of 100%.

Max Fallout—Breakdown: This insight centers on comparing the similarities and differences in the max fallout insight across various flow categories: [Max Fallout—Breakdown] Both Digital Specialist and Product Manager experienced the max number of fall out in Analyze, with 7,339 and 3,596 people respectively. Collaborate has the highest fall-out rate for both Digital Specialist (62.5%) and Product Manager (69.6%).

Flow Depth: This insight offers a summary of the disparity in pass-through rate by comparing flows across different categories: [Flow Depth] Digital Specialist has the most passing rate across all steps, with 15.8% people reaching Collaborate state, while Product Manager has the minimum passing rate of 10.1%.

A Sankey diagram is a specialized type of flow diagram designed to visualize the movement of resources or information among multiple entities. It is useful, for instance, in portraying the distribution of resources, such as energy, materials, or costs, within a system. Nodes represent entities, and the flow between them is illustrated by arrows or lines with varying widths, where the width corresponds to the quantity of the flow. Sankey Diagram are useful, for instance, for dissecting the customer journey, offering insights into the distribution of customer interactions across diverse touchpoints. In contrast to a fallout chart, which primarily focuses on the sequential drop-off in a linear process, the Sankey diagram provides a more comprehensive view by incorporating multiple checkpoints at each stage. One objective of constructing a Sankey Diagram is to pinpoint key convergence and divergence points, extracting valuable insights such as, for instance, the redistribution of customer traffic throughout different stages.

Unlike creating a fallout chart, which involves users identifying touchpoints in the anticipated trajectory, generating a Sankey diagram eliminates the need for users to specify these touchpoints. Though, analysts leverage predetermined touchpoints within the trajectory to streamline or filter the flow of interests, and the resulting forms of Sankey Diagram vary based on the analytics goal, insights for the Sankey Diagram are elucidated as follows.

Common entry: Analysts designate a common entry node from which the flow of all entities originates. This facilitates the analysis of traffic once it enters the system. In this scenario, analysts frequently emphasize the first touchpoint, illustrating how entities enter the system's flow. For diagrams employing the common entry structure, the insights extracted typically revolve around the following aspects.

Most popular flow: This insight highlights the trajectory that has the most entities in the flow, and the percentage of entities that flow through this path: [Most Popular Flow] The most popular flow followed the sequence Entry (Marketing Channel Detail)>t.co>Exit, accounting for 1% of the total visitors.

Top landing: This insight gives information about the most popular touchpoint after entering the system with the percentage of entities, and the subsequent touchpoint after the most popular touchpoint: [Top Landing] t.co is the top entry point comprising 3.1% visitors, with www.facebook.com as the leading subsequent touchpoint, accounting for 2% of t.co visitors.

Secondary landing: This insight provides additional information on some other touchpoints that are less popular as the top landing touchpoint, but have similar number of entities visited: [Secondary Landing] www.facebook.com serves as the secondary entry point with 2.5% visitors, followed by www.redit.com, Pinterest.com, and www.dailymotion.com, accounting for 2.1%, 2.1%, 1.6% of the total visitors.

Flow depth: This insight summarizes the number of steps each entity takes from entry to drop-off. Different from the flow depth insight in Fallout chart, this insight focuses on the length of the trajectory other than the pass-through rate: [Flow Depth] 30.9% of visitors experienced 1 Marketing Channel Detail before dropping off, while the rest of visitors reached the 2nd Marketing Channel Detail.

In a Common Exit configuration, the flow of all entities converges at a common exit node, providing analysts with the opportunity to scrutinize the traffic prior to entities departing the system. Analysts in this scenario tend to concentrate on the final touchpoint before entities exit, shedding light on the reasons behind their departure. Similar to the common entry diagram, the common exit diagram yields insights into the most prevalent flow patterns and depth. Additionally, this diagram type allows for the extraction of insights that shift analytical focus to the touchpoints associated with exiting.

Top drop-off: This insight illustrates the most popular touchpoints before entities leave the system with the percentage of entities, and what is the leading touchpoints to this most popular drop-off touchpoint: [Top Drop-off] Account Password Help exhibits the highest drop-off rate, comprising 15.4% of the people. purchase: step 2 is the most popular preceding touchpoint, accounting for 9.4% of people experienced Call Reason: Account Password Help.

Secondary drop-off: This insight gives additional touchpoints that have similar traffic compared to the top drop-off touchpoint: [Secondary Drop-off] The next highest drop-off consists of Payment Issue, Order Created and Payment Question, accounting for 12.9%, 12.5%, 11.5% of the people.

Common mid-point: Analysts filter the flow by determining a common touchpoint that all entities in the system go through. The trajectories of all entities in the Sankey Diagram will get aligned by this common touchpoint, which creates a picture for analysts to figure out what leads entities to this touchpoint, and what happens after this touchpoint. Generating insights and captions for this type of Sankey involves a combination of analysis from common exit diagram (before the mid-point), and the common entry diagram (after the mid-point). Similar to the above two types of diagrams, some aspects also extract the most popular flow and flow depth. In addition, support the following insights for the particular analytics goal of this diagram.

Preceding touchpoint: This insight gives an overview of the previous touchpoint before the mid-point, and the percentage of entities that went through the previous touchpoints: [Preceding Touchpoint] The majority of people (66.8%) entered from email Marketing Channel without preceding touchpoint. Display and mobile SMS are the most popular preceding touchpoint, accounting for 5.1% and 5.1% of the total people, respectively.

Subsequent touchpoint: This insight gives an overview of the follow-up touchpoints after the mid-point: [Subsequent Touchpoint] The majority of people (60.4%) dropped off after email Marketing Channel without subsequent touchpoint. Display, mobile SMS and social are the most popular subsequent touchpoint, accounting for 6.1%, 5.9%, 5.1% of the total people, respectively.

Most popular preceding flow: This insight emphasizes the most common path entities go through before reaching the mid-point: [Most Popular Preceding Flow] The majority of people (4.9%) reached email Marketing Channel through the path: entry>display>email.

Most popular subsequent flow: This insight highlights the most common path that entities go through after reaching the mid-point: [Most Popular Subsequent Flow] The most popular flow after email Marketing Channel followed the sequence email (Marketing Channel)>display>exit, accounting for 3.9% of the total people.

In accordance with some embodiments, a generative model used by the digital presentation generation system 102 to generate captions includes a neural network. As used herein, a neural network includes multiple operational layers, including an input layer and an output layer, as well as any number of hidden layers between the input layer and the output layer. Each layer includes neurons. Different types of layers and networks connect neurons in different ways. Neurons have weights, an activation function that defines the output of the neuron given an input (including the weights), and an output. The weights are the adjustable parameters that cause a network to produce a correct output. The neural network is trained to generate captions using training data that comprises insight data paired with target captions for each insight type. The neural network is iteratively trained by providing insight data to the model, which generates an output, comparing (e.g., using a loss function) the output against the target caption paired with the insight data in the training data, and updating the generative model based on the comparison (e.g., updating the weights via backpropagation).

As mentioned above, the digital presentation generation system 102 ranks a generated set of insights and selects a subset of insights from the ranked set of insights. For example, FIG. 5 shows the digital presentation generation system 102 utilizing a ranking model to select a subset of insights in accordance with one or more embodiments.

As shown in FIG. 5, the digital presentation generation system 102 generates a set of insights 502, where each of the insights include metadata (e.g., dimensions, metrics, values, and visualization). Moreover, FIG. 5 shows the digital presentation generation system 102 utilizing a ranking model 504 to rank the set of insights 502 (e.g., generate a ranked set of insights 506).

FIG. 5 shows that in some embodiments, the digital presentation generation system 102 receives a user specified parameter 505. As mentioned above, the user specified parameter 505 includes custom instructions submitted from user input via a computing device to guide the ranking model in ranking the set of insights 502 and/or to guide the digital presentation generation system 102 in selecting a subset of insights 508.

In other words, the user specified parameter 505 refers to a refinement of the selection and ranking process of insights by the digital presentation generation system 102. To illustrate, an analyst specifies that the ranking model 504 should focus on data corresponding to “a neutral sentiment” (e.g., the ranking model 504 might normally focus on data corresponding to a “very negative sentiment” or a “very positive sentiment”). Accordingly, the digital presentation generation system 102 uses the ranking model 504 during the ranking and selection steps to focus on insights that reference the “neutral sentiment.” In other words, the digital presentation generation system 102 assigns a higher weight to the indicated “neutral sentiment.”

In some embodiments, the digital presentation generation system 102 generates an initial ranking of the set of insights 502 and then receives the user specified parameter 505. In response, the digital presentation generation system 102 performs a reranking of the set of insights 502 based on the user specified parameter 505. In other words, the digital presentation generation system 102 references the user specified parameter 505 to guide the reranking process.

As shown in FIG. 5, the digital presentation generation system 102 utilizes the ranking model 504 and/or the user specified parameter 505 to generate the ranked set of insights 506. Furthermore, FIG. 5 shows the digital presentation generation system 102 selecting the subset of insights 508 from the ranked set of insights 506. In some embodiments, the digital presentation generation system 102 filters the set of insights 502 down to the subset of insights 508 based on the user specified parameter 505. In other words, the digital presentation generation system 102 selects the subset of insights 508 to use in generating a digital presentation.

In one or more embodiments, the digital presentation generation system 102 utilizes the ranking model 504 to rank the set of insights 502 according to a position of a visualization. As mentioned above, the digital presentation generation system 102 interprets a hierarchy of importance from customizing of an analytics dashboard. In particular, for a visualization that appears at the top of an analytics dashboard, the digital presentation generation system 102 determines that the visualization is relatively more important than other visualizations in the analytics dashboard. Accordingly, the digital presentation generation system 102 ranks the insight corresponding to that visualization accordingly.

In one or more embodiments, the digital presentation generation system 102 utilizes the ranking model 504 to rank the set of insights 502 according to a frequency of a dimension. For example, if a dimension of “negative sentiment” is present in every visualization of an analytics dashboard, the digital presentation generation system 102 determines that the dimension is relatively important. In particular, the digital presentation generation system 102 ranks an insight that contains the dimension “negative sentiment” higher than other insights with other dimensions that are not present in every visualization of the analytics dashboard.

The following description provides additional examples of how the digital presentation generation system 102 utilizes the ranking model 504. In one or more embodiments, the digital presentation generation system 102 utilizes the ranking model 504 to generate rankings of insights. In particular, the digital presentation generation system 102 generates a network representation of the set of insights 502 and ranks nodes and connections within the network representation.

The nodes and connections between the nodes of the network representation, for instance, are usable by the digital presentation generation system 102 to form a ranking, e.g., based on a number of connections, types of connections, and so forth. In one or more examples, the ranking is based on a weighting of types of connections exhibited by respective connections associated with the nodes.

The digital presentation generation system 102 utilizes the network representation to select a threshold number of nodes (e.g., a top ten percent) as a subset from the network representation. In some embodiments, the digital presentation generation system 102 ranks the nodes and connections of the network representation based on corresponding insights, connections, weights applied to particular types of connections, and so forth. For example, the digital presentation generation system 102 ranks insights based on values of score-based connections alone, rank insights based on a weighted combination of score-based connections (e.g., a weight of seventy percent) and layout-based connections, e.g., with a weight of thirty percent.

In one or more embodiments, the digital presentation generation system 102 ranks the nodes and connections of the network representation (e.g., representing the insights) based on frequency of dimensions associated with the insights and position of visualizations in a digital dashboard (e.g., of the analytics application) associated with the insights. In other words, if the dimension “very negative” sentiment for total calls by sentiment is frequently referenced in the insights, then the digital presentation generation system 102 ranks “very negative” as highly relevant in the rankings. Moreover, if an insight is associated with a visualization at a prominent part of the digital dashboard (e.g., top right corner of the digital dashboard), the digital presentation generation system 102 ranks the insight highly relative to other insights.

Given a set of insights automatically generated (e.g., for visualizations or tables in an analytics dashboard) by the digital presentation generation system 102, the digital presentation generation system 102 identifies five types of connections (e.g., categories) that are indicative of whether an insight is related (e.g., directly) to another insight.

A variety of connections are definable between the insights. In a first example, the digital presentation generation system 102 identifies layout-based connections that define how a digital dashboard informs relationships between insights. In a second example, the digital presentation generation system 102 identifies type-based connections that relate how a type of insight relates to other insights generated for a same digital dashboard.

In a third example, the digital presentation generation system 102 identifies topic-based connections that leverage how underlying dimensions and metrics impact insight relationships. In a fourth example, the digital presentation generation system 102 identifies temporal-based connections that are leveraged to control how insights are naturally ordered based on corresponding temporal value references in the source dataset. In a fifth example, the digital presentation generation system 102 generates score-based connections that leverage user preferences, compound metrics, and so forth as a gauge of impact of the “correctness” of multiple insights.

In some embodiments, the digital presentation generation system 102 leverages a layout of the analytics dashboard as an insight into intent of a creator of the digital dashboard. For example, items (e.g., sub-panels) located higher in the digital dashboard indicate that the corresponding information has a greater importance or involves frequent access than other items in the user interface. In some embodiments, a layout within a table indicates priority and/or the evolution of calculated metrics, e.g., often in reading-order.

Accordingly, the digital presentation generation system 102 addresses a variety of layout-related information for identifying a layout-based connection, examples of which include: (1) panel position, e.g., row and column of the sub-panel in an analytics dashboard; (2) table position, e.g., the row and column of a dimension or metric in an underlying table; (3) sort status, e.g., a column corresponding to the insight is sorted, rather than another column in the table; and (4) redundant encodings, e.g., multiple sub-panels correspond to same underlying data, such as both a visualization and table. In some embodiments, the digital presentation generation system 102 forms a clustering of insights using layout-based connections that mirrors an initial layout of the digital dashboard in order to generate the network representation as further described below.

In some embodiments, the digital presentation generation system 102 identifies a topic-based connection as a particular dimension or metric that occurs within multiple sub-panels of a dashboard, thereby suggesting that the topic is of particular interest to the dashboard-creator. While there is some overlap with the layout-based connections, topic-based connections are usable to directly co-locate related insights that occur at different locations throughout the analytics dashboard. Topic-based connections are also usable to consider other features of the source dataset, such as filters or segments. In the analytics dashboard, subheadings are used to breakdown a dimension.

In some embodiments, the digital presentation generation system 102 identifies a type-based connection as another form of connection that is independent of layout and topic. For example, a focus is given to analyzing spikes that occur in the data, regardless of which topic or sub-panel include the spikes. Further, in some embodiments, the digital presentation generation system 102 is implemented to identify temporal-based connections that are usable to provide an intuitive ordering to the insights and thus denote another form of connection that is independent from the layout, insight-type, and topic categories above. While singular date/time references are straightforward to cluster as part of forming a network representation as further described below, a notable complexity arises when working with both singular and ranged values.

In some embodiments, the digital presentation generation system 102 calculates score-based connections between insights. The previous categories relate to intrinsic properties of the insights and thus do not support general-purpose explorations of the data in some scenarios, e.g., to surface the five “most important” insights. To support this form of exploration, the digital presentation generation system 102 supports a category of score-based connections, e.g., compound connections. For example, a score is specified for each insight that combines a priority from the layout-based connection (e.g., position, sorting, etc.) with a measure of prevalence of the insights, e.g., a number of times the values mentioned in the insight compared to each of the other insights.

A weighted “priority” score, for instance, is defined as: score=0.3*layoutScore+0.7*valueScore which gives a higher weight to the mentioned values compared to the overall layout. The digital presentation generation system 102 computes the “layoutScore” as follows: layoutScore=0.25*panelRow+0.25*panelCol+0.35*tableCol+0.15*isSorted.

The “panelRow,” “panelCol,” and “tableCol” scores are computed as: 1−x/max(x), where “x” is either a panel row index, panel column index, or table column index for the insight and “max(x)” is a maximum value for the entire digital dashboard 126. Next, the digital presentation generation system 102 computes the “valueScore” as follows: (1) count the occurrences for all nominal values or dates across all of the generated insights; AND (2) for each insight, compute the average occurrence as “avgOcc=1/n*Σvᵢ−1.” where “vᵢ” is the count of the value or date and “n” is the number of unique values or dates mentioned in the insight; and (3) compute the “valueScore” by adjusting the “avgOcc” for the insight based on the min or max for each of the insights in the digital dashboard: valueScore=(vScore−min(vScore))/(max(vScore)−min(vScore)).

The score-based links are extendable to cover a variety of unique formula or combination of other scores. A variety of other examples of connections are also contemplated. In some embodiments, the insight connections are then passed as an input to the ranking model 504 to generate a network representation. In some embodiments, the digital presentation generation system 102 utilizes the ranking model 504 to generate a network representation having nodes that correspond to the insights. The nodes are connected within the network representation based on the insight connections. In this way, the network representation provides a representation of interrelations between insights from the source dataset and the analytics dashboard and thus is usable to form a ranking of nodes and connections with the network representation.

In an implementation, the network representation is extended through use of “gatekeeping nodes.” The large variety of connections and corresponding insights support a variety of ways to explore the source dataset (e.g., the analytics dashboard). However, determining which type of links that are of interest remains difficult. To address this technical challenge, the digital presentation generation system 102 configures the ranking model 504 to support a flexible exploration environment as part of generating the network representation through addition of gatekeeping nodes for each insight-type, topic, and score available in the network representation.

The gatekeeping nodes, for instance, are configurable to support specific types of connections, which are usable to dictate when certain links for the given insight node are surfaced. In some embodiments, the digital presentation generation system 102 utilizes the ranking model 504 to create a topic node for each data column (i.e., metric).

The digital presentation generation system 102 utilizes the ranking model 504 to further add one topic node for each item's (e.g., sub-panel's) dimension. The digital presentation generation system 102 utilizes the ranking model 504 to additionally create extra nodes for sub-panels that include a segment-level breakdown, i.e., a second dimension. Finally, additional nodes are further usable to group the insights (and topics) by the higher-level topic.

As mentioned above, the digital presentation generation system 102 generates narrative grouping structures from a selected subset of insights. For example, FIG. 6 shows the digital presentation generation system 102 generating narrative grouping structures by comparing a similarity score of various insights to different thresholds in accordance with one or more embodiments.

As mentioned above, the digital presentation generation system 102 generates/selects a subset of insights 602 from the ranked set of insights. In particular, FIG. 6 shows the digital presentation generation system 102 generating the subset of insights 602 that includes an order of the insights (e.g., (7), (2), (1), (3) . . . ). Moreover, FIG. 6 shows the digital presentation generation system 102 performing an act 604 of generating narrative grouping structures from the subset of insights 602.

In some embodiments, the digital presentation generation system 102 groups insights together based on sections in order to provide a larger overarching narrative structure. In other words, the narrative grouping structures are groups of insights that will either be placed in the same digital slide, the same section of a digital presentation, or different sections of the digital presentation. Moreover, in some embodiments, the digital presentation generation system 102 identifies points in a narrative order where there is a threshold shift in topic between two digital slides (e.g., multiple changing dimensions, metrics, and/or values) and adds section headers at those points.

As shown in FIG. 6, the digital presentation generation system 102 generates the narrative grouping structures by performing an act 606 of comparing similarity of insights. In particular, the digital presentation generation system 102 compares an insight with another insight or compares a representation of an insight with another insight to determine how similar the insight is with another insight.

As shown, the digital presentation generation system 102 compares insight (7) with insight (2) and determines whether the insights satisfies various thresholds of similarity. In one or more embodiments, the digital presentation generation system 102 compares insights with each other by comparing the metadata of the insights. In particular, the digital presentation generation system 102 compares the dimensions, the metrics, the values, and the visualizations of the insights with each other to determine how similar the insights are with each other.

In some embodiments, the digital presentation generation system 102 establishes a hierarchy of the metadata. In particular, the digital presentation generation system 102 establishes a hierarchy in the order of dimensions, metrics, values, and then visualizations when comparing the insights. In other words, the digital presentation generation system 102 assigns a higher weight to similar dimensions between insights and a slightly lower weight to similar metrics between insights. Accordingly, the digital presentation generation system 102 generates a similarity sub-score for each piece of metadata and then combines each of the sub-scores to generate a similarity meta-score for each comparison between insights.

As mentioned above, the digital presentation generation system 102 utilizes various machine learning principles to perform the task of generating digital presentations. In some embodiments, the digital presentation generation system 102 utilizes machine learning principles for generating the narrative grouping structures. In particular, the digital presentation generation system 102 utilizes text encoders to encode the subset of insights 602 and compare the subset of insights 602 with each other in a unified embedding space.

In one or more embodiments, the digital presentation generation system 102 utilizes a text encoder to generate a first set of text tokens for a first caption of a first insight and a second set of text tokens for a second caption of a second insight. Moreover, the digital presentation generation system 102 compares the first set of text tokens with a second set of tokens (e.g., using a large language model) to generate a similarity score between the first insight and the second insight.

Although not shown in FIG. 6, the digital presentation generation system 102 compares each of the insights in the subset of insights 602 with each other to generate respective similarity scores for each of the comparisons. In particular, the digital presentation generation system 102 generates a first similarity score (e.g., between a comparison between (7) and (2)), a second similarity score (e.g., between a comparison between (7) and (1)), a third similarity score (e.g., between a comparison between (7) and (3)), a fourth similarity score (e.g., between a comparison between (2) and (1)), a fifth similarity score (e.g., between a comparison between (2) and (3)), and a sixth similarity score (e.g., between a comparison between (1) and (3)).

Moreover, in some embodiments, the digital presentation generation system 102 utilizes an image encoder to encode visualizations (e.g., charts) corresponding to insights from the subset of insights 602. In particular, the digital presentation generation system 102 generates image embeddings from the visualizations and then further utilizes a projector to project the image embeddings into the unified embedding space. In doing so, the digital presentation generation system 102 further compares image tokens (e.g., the representation of the image embeddings in the unified embedding space) with the text tokens.

As such, the digital presentation generation system 102 accurately and efficiently compares the image domain of the subset of insights 602 with each other to determine a measure of similarity (e.g., a similarity score). For instance, the digital presentation generation system 102 generates measures of similarity using a multi-modal large language model that processes both the text and image domain.

In some embodiments, the digital presentation generation system 102 uses multiple thresholds to determine whether insights should be grouped together in the same digital slide, grouped together in the same section, or put in separate sections. In particular, the digital presentation generation system 102 determines whether a similarity score satisfies a highly related threshold 608. If it does, the digital presentation generation system 102 groups the two insights together in the same digital slide.

Further, in some embodiments, the digital presentation generation system 102 determines whether a similarity score satisfies a related threshold 610, if it does, the digital presentation generation system 102 groups the two insights in the same section of a digital presentation. Moreover, in some embodiments, the digital presentation generation system 102 determines whether a similarity score fails to satisfy 612 a related threshold, if it does, the digital presentation generation system 102 keeps the two insights in separate sections of the digital presentation. For example, the digital presentation generation system 102 establishes a highly related threshold at 90% similarity and a related threshold at 70% similarity.

As further shown, the digital presentation generation system 102 generates a digital presentation outline 614 from the narrative grouping structures. In one or more embodiments, the digital presentation generation system 102 generates the digital presentation outline 614 according to the narrative grouping structures. In particular, the digital presentation outline 614 refers to a narrative structure and ordering of insights (e.g., the set of insights or the subset of insights).

To illustrate, in some embodiments, the digital presentation outline 614 indicates a first section that contains five digital slides, a second section that contains three digital slides, and a third section that contains four digital slides. In particular, the digital presentation outline 614 further indicates that the first digital slide contains a first insight and a second insight (e.g., a first narrative grouping structure); the second digital slide contains a third insight (e.g., a second narrative grouping structure); the third digital slide contains a fourth, fifth, and sixth insight (e.g., a third narrative grouping structure); and the fourth digital slide contains a seventh insight (e.g., a fourth narrative grouping structure).

In other words, the digital presentation generation system 102 generates the digital presentation outline 614 that outline an entire digital presentation (e.g., outlines the specific visualizations, dimensions, metrics, and values shown in each digital slide of the digital presentation). In particular, FIG. 6 shows the digital presentation outline 614 with a first group (e.g., a first narrative grouping) containing the seventh and second insight, and a second group (e.g., a second narrative grouping) containing the first insight, and so forth.

As mentioned above, the digital presentation generation system 102 generates a digital presentation from a digital presentation outline. FIG. 7 illustrates the digital presentation generation system 102 using a presentation generation model to generate a digital presentation in accordance with one or more embodiments. For example, FIG. 7 shows the digital presentation generation system 102 generating/accessing a digital presentation outline 702. In particular, FIG. 7 shows that the digital presentation outline 702 contains a first, second, third, and fourth group (e.g., four narrative grouping structures), where each group indicates specific insights and associated metadata for the insights.

As shown in FIG. 7, the digital presentation generation system 102 uses a presentation generation model 704 to process the digital presentation outline 702 and generate a digital presentation 706. In some embodiments, the digital presentation generation system 102 converts the digital presentation outline 702 into the digital presentation 706 by initially selecting a digital presentation template from a plurality of digital presentation templates that conform with style characteristics of the digital presentation outline 702.

In some embodiments, the digital presentation outline 702 indicates a donut chart visualization, a histogram, and a bar graph for ice cream flavor data. Because the data is for “ice cream flavor data” the digital presentation generation system 102 prompts a presenter/analyst for a theme to tailor to for creating the digital presentation 706. In other words, the digital presentation generation system 102 provides a presenter/analyst with operational flexibility and the ability to control the overall look and feel of the digital presentation (e.g., the template is selected based on user input).

As shown in FIG. 7, the digital presentation generation system 102 further generates the digital presentation 706 by matching each group to a specific digital slide in the digital presentation 706 and further assigns a target layout to each digital slide. Furthermore, the digital presentation generation system 102 identifies a target layout for each slide of the digital presentation 706 based on the type of visualization and data (e.g., metric, dimension, values) for a specific digital slide. In other words, a target layout depends on the space needed to display certain visualizations.

In one or more embodiments, a digital presentation template refers to a pre-designed, customizable framework with consistent organized layouts for the digital slides. In particular, the digital presentation template contains similar arrangements of text, images, charts, graphics, and other elements. For example, the digital presentation generation system 102 receives a selection from a presenter/analyst of a template from business templates, educational templates, creative templates, academic templates, pitch deck templates, whimsical templates, bright-and-bold templates, professional templates, or conference templates to tailor the digital presentation 706 after. In other words, the digital presentation generation system 102 provides customization of the digital presentation 706 for a presenter/analyst to choose the visualization and the text content.

As mentioned above, the digital presentation generation system 102 selects a target layout for a digital slide based on the insight(s) that will be placed in the digital slide. In particular, the digital presentation generation system 102 selects a target layout that includes colors, fonts, graphics, icons, and a background. In some embodiments, the digital presentation generation system 102 determines the digital presentation template and the target layout based on a number of visualizations indicated in the digital presentation outline 702, a number of insights indicated in the digital presentation outline 702, the amount of metadata for each insight, and a short and long title for each insight in the digital presentation outline 702.

Additionally, after the digital presentation generation system 102 has selected the target layouts, the digital presentation generation system 102 maps the digital presentation outline 702 into the digital presentation 706. In particular, the digital presentation generation system 102 identifies each referenced narrative grouping structure and determines whether the insights are supposed to be placed in the same digital slide, the same section, or different sections (e.g., as discussed above in FIG. 6).

As shown in FIG. 7, in one or more embodiments, the digital presentation generation system 102 further performs an act 705 of data filtering and highlighting. In particular, the data from the source dashboard (e.g., the digital dashboard of the analytic application) is often complex and contains many values. Because of this, the digital presentation generation system 102 filters/highlights data to create a more effective communication presentation (e.g., digital presentation). For example, the digital presentation generation system 102 filters data (e.g., hides data) to focus on the most important values for an insight in a digital slide.

In one or more embodiments, the digital presentation generation system 102 determines the target layout for a digital slide and further determines a threshold amount of space for the target layout. In particular, based on the threshold amount of space (e.g., 80% of the digital slide is used for content), the digital presentation generation system 102 determines an amount of data to filter out for the insight. In other words, the digital presentation generation system 102 determines an aspect ratio for each digital slide to maintain legibility for each digital slide. To illustrate, for a visualization that includes one hundred and twenty values, the digital presentation generation system 102 determines to filter out 98 values.

In one or more embodiments, the digital presentation generation system 102 further improves accuracy and transparency in the digital presentation 706 by generating a label to display on the digital slide that describes an amount of hidden data. In particular, the label reads “98 values have been filtered out.” Moreover, in some embodiments, the digital presentation generation system 102 further highlights the reference values in the visualization that is created for each digital slide. For instance, the digital presentation generation system 102 highlights (e.g., boldens, adds a color, fills in, etc.) a specific dimension (e.g., negative sentiment, chocolate chip ice cream), such as the specific reference value for the “greatest decrease in average rating.”

As shown in FIG. 7, in one or more embodiments, the digital presentation generation system 102 further generates presenter notes 708. In particular, the digital presentation generation system 102 generates presenter notes which provide a presenter with key talking points for each slide. Moreover, in some embodiments, the digital presentation generation system 102 adds insights that are relevant to a digital slide but filtered due to space and style limitations to the presenter notes 708.

In other words, the digital presentation generation system 102 generates the presenter notes 708 (via a presenter note interface) that could be useful for a presentation. To illustrate, the digital presentation generation system 102 generates the presenter notes 708 that read “source insight [rank 1]: billing questions had the highest value, with 23,461 in calls, which is 71% of the total.” To further illustrate, the digital presentation generation system 102 generates the presenter notes 708 that read “Source Insight [rank 2]: “Negative” had the greatest value, with 11,063 in “Calls” (34% in total); Source Insight [rank 15]: “Negative” had the greatest value, with 11,063 in “Calls” (34% in total); Source Insight [rank 23]: The max attribute, “Negative”, is 26% more than the second highest one, “Neutral”, in Calls.”

In one or more embodiments, the digital presentation generation system 102 generates the presenter notes 708 based on insights shown in a digital slide. In particular, the digital presentation generation system 102 focuses on generating the presenter notes 708 that contain filtered data from the insights shown in a digital slide such that a presenter has additional context to explain hidden data, or the significance of an insight shown in a digital slide. In one or more embodiments, the digital presentation generation system 102 provides a scale for a presenter to indicate the length and breadth of the presenter notes 708.

In some embodiments, the digital presentation generation system 102 utilizes a large language model to generate the presenter notes 708. In particular, the digital presentation generation system 102 generates a prompt that includes the content shown in a digital slide and the associated metadata and instructs a large language model to generate the presenter notes 708. Moreover, in some embodiments, the digital presentation generation system 102 further instructs the large language model to shorten (e.g., paraphrase) or lengthen (e.g., include additional context) the presenter notes 708.

As shown in FIG. 7, the digital presentation generation system 102 further combines the digital presentation 706 with the presenter notes 708. In particular, the digital presentation generation system 102 generates presentable slides with the presenter notes 708 such that a presenter is able to seamlessly present the on-the-fly generated presentation. For example, in a presenter view of the digital presentation 706 (e.g., the includes the digital presentation 706 and the presenter notes 708 shown in a presenter note interface), the digital presentation generation system 102 provides for display first presenter notes for a first group, second presenter notes for a second group, etc.

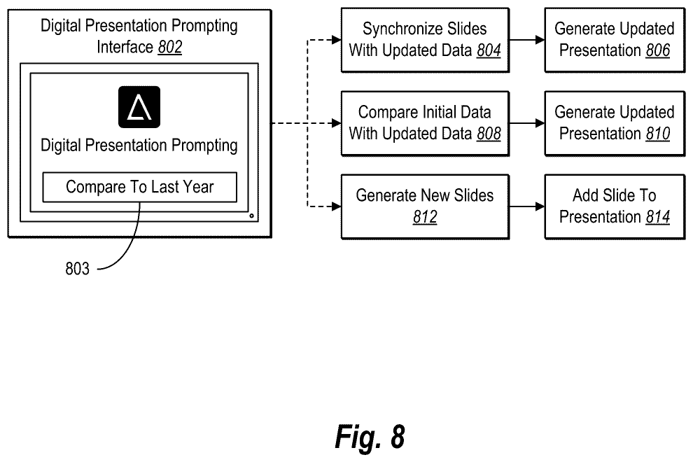

As mentioned above, the digital presentation generation system 102 provides a digital presentation prompting interface. FIG. 8 illustrates the digital presentation generation system 102 synchronizing slides with updated data, comparing data, and generating new slides in accordance with one or more embodiments. For example, FIG. 8 shows the digital presentation generation system 102 providing a digital presentation prompting interface 802 for a presenter to submit prompts. In particular, the digital presentation prompting interface 802 allows a presenter (e.g., during a presentation) to instruct the digital presentation generation system 102 to synchronize/update/generate new slides for a digital presentation.

In one or more embodiments, the digital presentation prompting interface 802 provides for on-the-fly updates of the digital presentation. In particular, the digital presentation prompting interface 802 allows for a presenter to adapt their digital presentation to audience questions. In other words, the digital presentation generation system 102 allows for dynamic modifications of a digital presentation in an efficient and accurate manner. As shown in FIG. 8, the digital presentation generation system 102 receives a prompt 803 of “compare to last year,” indicating that the presenter would like to compare a current digital slide in the digital presentation to last year's data.

FIG. 8 shows that in some embodiments, the digital presentation generation system 102 performs an act 804 of synchronizing slides with updated data. In one or more embodiments, the analytics dashboard of the analytics application is not a static artifact, the data is often updated and monitored over a period of time. In contrast, presentation slides are static in existing systems. As highlighted above, in existing systems, it is a challenging task to pull data into a digital presentation and the process for updating digital presentations is an error-prone process.

In one or more embodiments, the digital presentation generation system 102 counters the aforementioned issues by intelligently updating digital slides in a digital presentation to showcase changes or comparisons between presentations. For example, the digital presentation generation system 102 generates a digital presentation for the first quarter (Q1) and a presenter presenting the digital presentation is asked to share an update on progress in the second quarter (Q2). Rather than generating an entirely new presentation for Q2, the analyst updates the Q1 presentation with comparisons to show how the data has changed (e.g., the digital presentation generation system 102 performs an act 806 of generating an updated presentation).

In one or more embodiments, the digital presentation generation system 102 performs the act 804 of synchronizing the slides with the updated data by querying the digital presentation generation system 102 to compare all the slides in the digital presentation with Q2. In doing so, the digital presentation generation system 102 generates an updated version of the digital presentation that synchronizes the slides with an updated dataset (e.g., data that includes Q2).

As also shown in FIG. 8, in some embodiments, the digital presentation generation system 102 performs an act 808 of comparing initial data with updated data. In particular, in response to a query/prompt submitted by an analyst/presenter, the digital presentation generation system 102 runs a comparison analysis between a previous dataset and a new dataset and creates new comparison charts with updated insights that include an analysis of changes and/or trends (e.g., the digital presentation generation system 102 performs an act 810 of generating an updated presentation that includes the same slides that are updated according to the comparison or includes additional slides added to the initial digital presentation).

As also shown in FIG. 8, in some embodiments, the digital presentation generation system 102 performs an act 812 of generating new slides. As mentioned above, while presenters are typically prepared very well for presentations, presenters are often faced with unanticipated questions from the audience. In one or more embodiments, the digital presentation generation system 102 supports a workflow of asking additional questions and adding additional digital slides on-the-fly. In particular, the digital presentation generation system 102 utilizes the principles discussed above (e.g., the user specified parameter) to extract certain insights from the data extracted from the analytics application.

Moreover, in some embodiments, the digital presentation generation system 102 utilizes the additional insights (e.g., generated from the prompt 803 and the user specified parameter) to generate new slides. Further, in some embodiments, the digital presentation generation system 102 performs an act 814 of adding the new slides to the presentation. Thus, the digital presentation generation system 102 provides on-the-fly generative capabilities for enhancing/modifying a digital presentation.

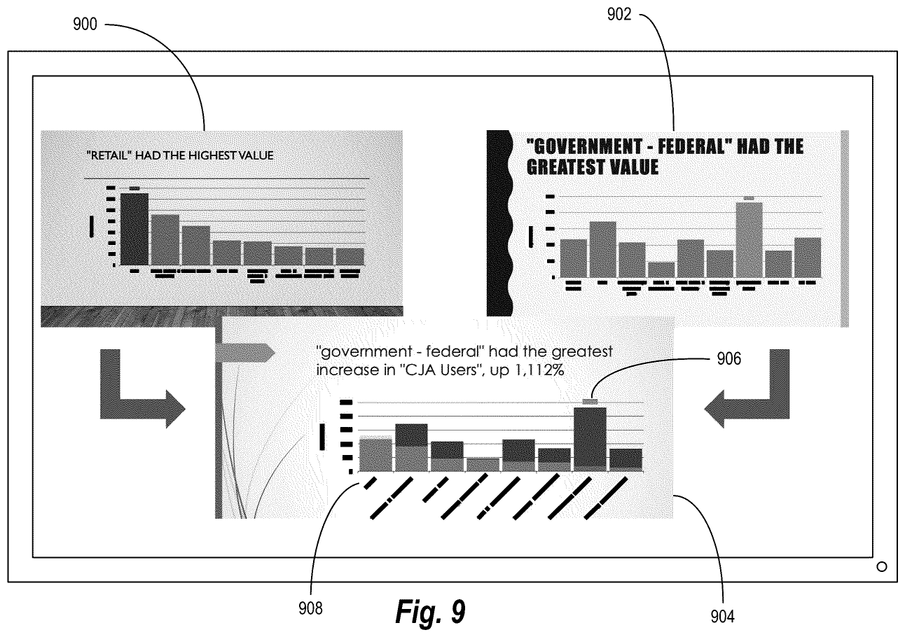

As mentioned above, the digital presentation generation system 102 performs a comparison of initial data with updated data to generate an updated presentation. FIG. 9 illustrates the digital presentation generation system 102 comparing different datasets with each other to generate an updated digital slide (e.g., generate a comparison insight) in accordance with one or more embodiments.

As shown in FIG. 9, the digital presentation generation system 102 initially generates an initial digital slide 900 that shows “retail” as having the highest value. In particular, the initial digital slide 900 is based on an initial dataset from the analytics application. Moreover, FIG. 9 also shows the digital presentation generation system 102 generating an additional digital slide 902 that shows the “government-federal” as having the greatest value. In other words, based on updated data, the digital presentation generation system 102 generates a different digital slide that shows a different dimension for the insight of greatest value.

Moreover, FIG. 9 shows the digital presentation generation system 102 generating an updated digital slide 904. In particular, in response to receiving a prompt (e.g., from a digital presentation prompting interface), the digital presentation generation system 102 compares the initial digital slide 900 with the additional digital slide 902. For example, if a presenter is presenting a digital presentation with the additional digital slide 902 and submits a prompt to compare the additional digital slide 902 to an initial dataset (e.g., corresponding to the initial digital slide 900), the digital presentation generation system 102 generates the updated digital slide 904.

In one or more embodiments, the digital presentation generation system 102 uses a user specified parameter to filter the data in the analytics application to identify an insight of greatest value for the relevant dimensions and to further perform a comparison of a first timeframe with a second timeframe. In doing so, the digital presentation generation system 102 generates the updated digital slide 904. As shown in FIG. 9, the updated digital slide 904 specifically compares dimensions common to both the initial digital slide 900 and the additional digital slide 902 (e.g., shows how a dimension changed from one timeframe to another timeframe).

To illustrate, the updated digital slide 904 has an insight of “government-federal” had the greatest increase in “CJA Users”, (e.g., Customer Journey Analytics) up 1,112%. In particular, the updated digital slide 904 portrays a reference 908 that indicates the “retail” dimension and also portrays a reference 906 that indicates the “government—federal” dimension. As shown, the greatest value (from a comparison of the initial digital slide 900 with the additional digital slide 902) is the “government—federal” dimension. In some embodiments, the updated digital slide 904 shows each of the “bars” of the bar graph separated by different timeframes. In other words, each bar indicates its value for a first timeframe and a second timeframe to show how a specific dimension changed over that timeframe.

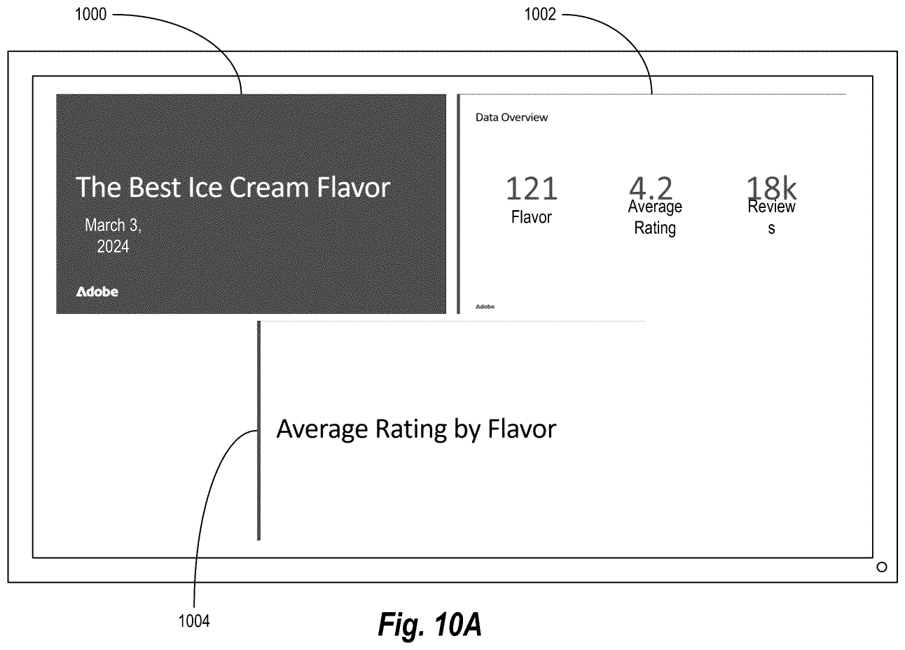

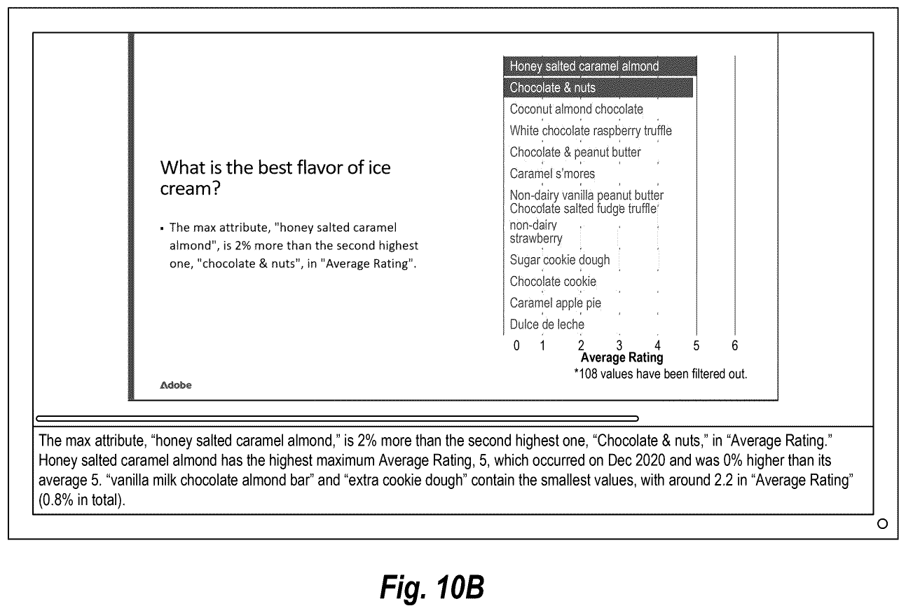

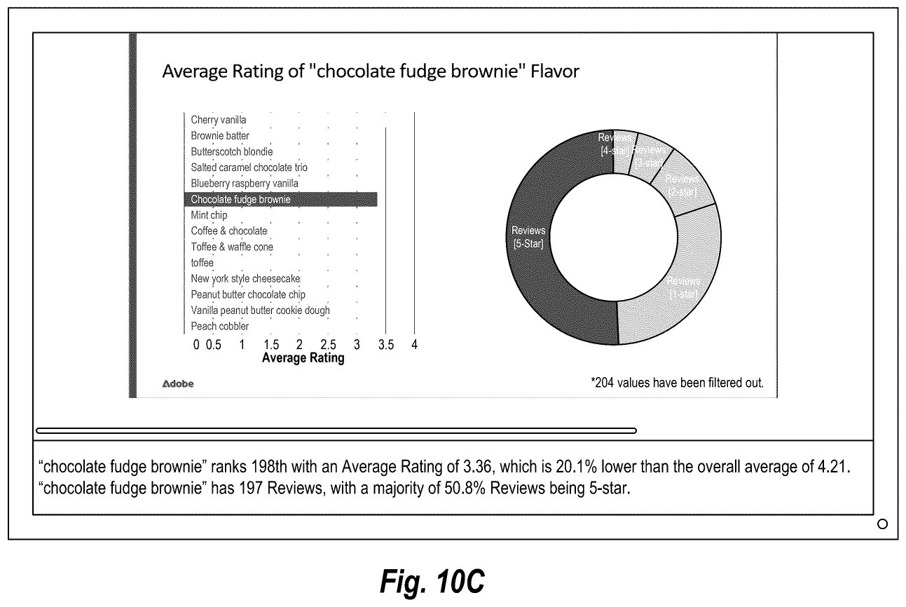

FIGS. 10A-10C illustrates an example digital presentation generated by the digital presentation generation system 102. For example, FIG. 10A shows a plurality of digital slides of a digital presentation. In particular, FIG. 10A shows a title slide 1000 that is generated from a digital presentation outline that indicates an overarching subject/topic of the analyzed data (e.g., ice cream).

Moreover, FIG. 10A shows an overview slide 1002 that is also generated from the digital presentation outline that indicates high-level information, that in some embodiments, was displayed at the top of an analytics dashboard. Additionally, FIG. 10A shows a section slide 1004 that was generated from the digital presentation outline. In particular, the digital presentation generation system 102 identifies a narrative grouping structure that encompasses a section of “average rating by flavor” and further groups insights that match the section topic of “average rating by flavor.”

FIG. 10B illustrates a digital slide containing an insight into the best flavor of ice cream. For example, FIG. 10B provides an insight that “the max attribute, “honey salted caramel almond”, is 2% more than the second highest one, “chocolate & nuts,” in “Average Rating.” Moreover, FIG. 10B shows a bar graph visualization of the best flavors of ice cream and their associated average rating. In particular, each of the ice cream flavors are dimensions, the average rating is a metric, and the actual average rating (1, 2, 3, 4, 5, etc.) for each dimension is a value.

Furthermore, as shown in FIG. 10B, the digital presentation generation system 102 generates presenter notes. In particular, the presenter notes read that “the max attribute, “honey slated caramel almond: is 2% more than the second highest one, Chocolate & nuts,” in “Average Rating.” Further, the presenter notes read “Honey salted caramel almond has the highest maximum average rating, 5, which occurred on December 2020 and was 0% higher than its average 5. Moreover, the presenter notes read “vanilla milk chocolate almond bar” and “extra cookie dough” contain the smallest values, with around 2.2 in “average rating” (0.8% in total).

FIG. 10C illustrates a digital slide containing an insight into an average rating of the flavor of “chocolate fudge brownie.” In particular, FIG. 10C shows both a bar graph and a donut chart for chocolate fudge brownie. In addition, FIG. 10C (e.g., like FIG. 10B) shows a label that indicates hidden content. In particular, the label reads that “*204 values have been filtered out.” Moreover, FIG. 10C shows presenter notes of “chocolate fudge brownie” ranks 198th with an average rating of 3.36, which is 20.1% lower than the overall average of 2.21. “Chocolate fudge brownie” has 197 reviews, with a majority of 50.8% reviews being 5-star.”

FIGS. 10A-10C show various digital slides. As mentioned above, the digital presentation generation system 102 utilizes an intelligent captioning model to generate insights (e.g., best flavor of ice cream) and generate captions for insights. Further, the digital presentation generation system 102 utilizes a ranking model to rank the generated insights, generates narrative grouping structures, and then the digital slides shown in FIGS. 10A-10C.

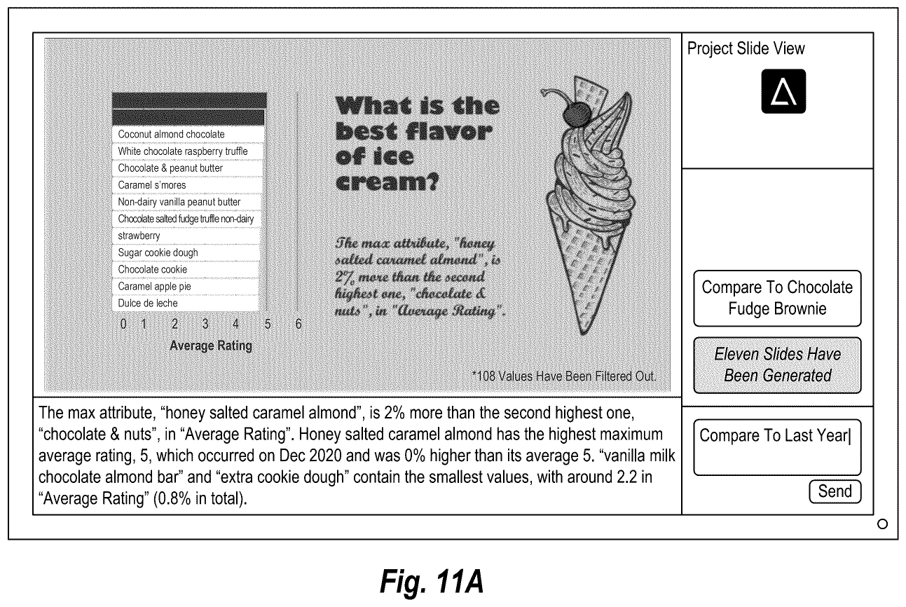

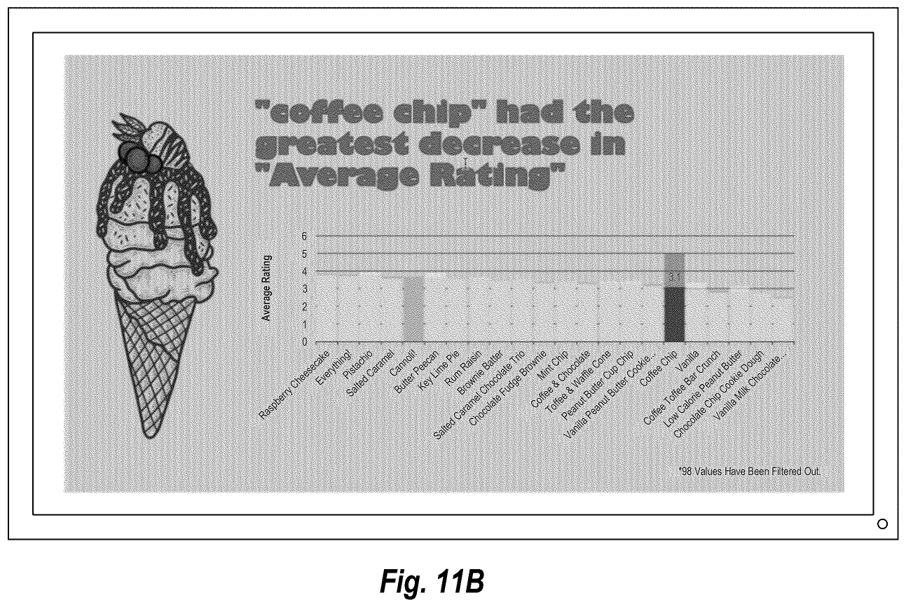

FIGS. 11A-11B illustrate an additional example of a digital presentation and the digital presentation generation system 102 providing a digital presentation prompting interface. FIG. 11A shows a digital slide for the best flavors of ice cream. In particular, FIG. 11A shows a bar graph with various different ice cream flavors (e.g., dimensions) and their corresponding average rating. Moreover, FIG. 11A shows the digital presentation prompting interface where a presenter submits prompts. In particular, FIG. 11A shows the digital presentation generation system 102 receiving a prompt of “compare to chocolate fudge brownie” and the digital presentation generation system 102 responds by generating eleven slides.

FIG. 11A further shows the digital presentation generation system 102 receiving an additional prompt of “compare to last year.” In particular, the additional prompt causes the digital presentation generation system 102 to compare the data of the digital slide shown in FIG. 11A with data of the average rating of ice cream flavors from a year prior. In doing so, the digital presentation generation system 102 further generates one or more digital slides to show a comparison between the current slide and data from last year.

FIG. 11B shows the digital presentation generation system 102 generating an updated digital slide. In particular, in response to a prompt submitted via a digital presentation prompting interface, the digital presentation generation system 102 generates an updated digital slide. For example, the updated digital slide contains a comparison of the average rating of ice cream flavors from one year to the next. Specifically, FIG. 11B shows an updated digital slide that shows that the flavor of coffee chip decreased from an average rating of 5 to a new average rating of 3.1 from one year to the next. Thus, FIGS. 11A-11B illustrates the ability of the digital presentation generation system 102 to provide on-the-fly generation of digital slides.

Turning to FIG. 12, additional detail will now be provided regarding various components and capabilities of the digital presentation generation system 102. In particular, FIG. 12 illustrates an example schematic diagram of a computing device 1200 (e.g., the server device(s) 104 and/or the client device 110) implementing the digital presentation generation system 102 in accordance with one or more embodiments of the present disclosure for components 1200-1212. As illustrated in FIG. 12, the digital presentation generation system 102 includes an insight manager 1202, an intelligent captioning model 1204, a narrative grouping structure manager 1206, a digital outline manager 1208, a digital presentation manager 1210, and a storage manager 1212.

The insight manager 1202 analyzes data from an analytics dashboard and extracts/generates insights. For example, the insight manager 1202 uses the intelligent captioning model to generate a set of insights from the data, and the insights further include various metadata. Specifically, the insight manager 1202 interprets data and extracts “important” insights (e.g., based on using a trained intelligent captioning model) to provide to an analyst/presenter. In some embodiments, the insight manager 1202 generates a set of insights where each insight is associated with dimensions, metrics, values, and visualizations.

The intelligent captioning model 1204 performs a variety of tasks such as analyzing visualizations, dimensions, metrics, and values to generate a set of insights. Specifically, the intelligent captioning model 1204 applies different weights to the visualizations, dimensions, metrics, and values to generate the set of insights. Furthermore, the intelligent captioning model 1204 uses the applied weights to generate predictions/outputs of insights corresponding to the extracted data. In some embodiments, the intelligent captioning model 1204 is trained on a training dataset to minimize a measure of loss between an output prediction and a ground truth reference. In doing so, the intelligent captioning model 1204 is fine-tuned to accurately and efficiently generate a set of insights. Moreover, in some embodiments, the intelligent captioning model 1204 further generates captions for the set of insights.

The narrative grouping structure manager 1206 organizes a set of insights into various narrative grouping structures. Specifically, the narrative grouping structure manager 1206 groups insights together based on similarity of insights with each other. For example, the narrative grouping structure manager 1206 transforms insights into token representations and compares them with each other to determine a similarity score for each insight. Moreover, the narrative grouping structure manager 1206 then compares each similarity score to different thresholds to determine how to group the insights. Specifically, the narrative grouping structure manager 1206 generates groupings that include a single insight or multiple insights.

The digital outline manager 1208 generates a digital presentation outline. Specifically, the digital outline manager 1208 takes the narrative grouping structures and constructs an outline that dictates how a digital presentation is arranged. For instance, the digital outline manager 1208 dictates an order of a digital presentation, one or more insights to include with each digital slide, visualizations, dimensions, metrics, and values to include with each slide, and different sections of a digital presentation.

The storage manager 1212 stores various components discussed in FIG. 14. For example, the storage manager 1212 stores the intelligent captioning model 1204, ranking model, data of an analytics application, sets of insights, captions for the insights, metadata of the insights, narrative grouping structures, digital presentation outlines, generated digital presentations, prompts, and additional slides generated on-the-fly. Additionally, the storage manager 1212 also stores training components such as a training dataset (e.g., analytics data, ground truth insights for the analytics data, and ground truth rankings) and the generated predictions used to train the intelligent captioning model 1204 and/or the ranking model.

Each of the components 1200-1212 of the digital presentation generation system 102 include software, hardware, or both. For example, the components 1200-1212 include one or more instructions stored on a computer-readable storage medium and executable by processors of one or more computing devices, such as a client device or server device. When executed by the one or more processors, the computer-executable instructions of the digital presentation generation system 102 cause the computing device(s) to perform the methods described herein. Alternatively, the components 1200-1212 include hardware, such as a special-purpose processing device to perform a certain function or group of functions. Alternatively, the components 1200-1212 of the digital presentation generation system 102 include a combination of computer-executable instructions and hardware.

Furthermore, the components 1200-1212 of the digital presentation generation system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1200-1212 of the digital presentation generation system 102 may be implemented as a stand-alone application, such as a desktop or mobile application. Furthermore, the components 1200-1212 of the digital presentation generation system 102 may be implemented as one or more web-based applications hosted on a remote server. Alternatively, or additionally, the components 1200-1212 of the digital presentation generation system 102 may be implemented in a suite of mobile device applications or “apps.” For example, in one or more embodiments, the digital presentation generation system 102 comprise or operate in connection with digital software applications such as ADOBE® ANALYTICS and ADOBE® EXPRESS.

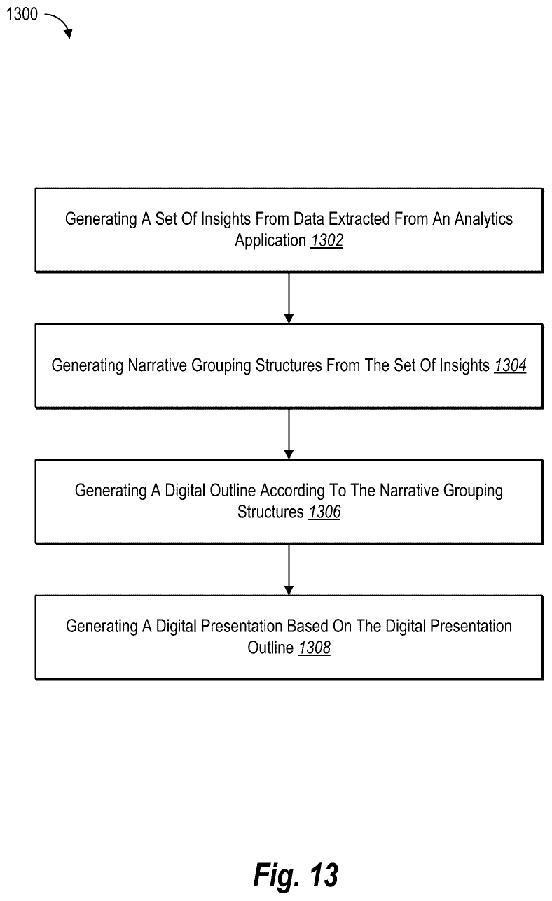

FIGS. 1-12, the corresponding text, and the examples provide a number of different methods, systems, devices, and non-transitory computer-readable media of the components 1202-1210. In addition to the foregoing, one or more embodiments are described in terms of flowcharts comprising acts for accomplishing the particular result. For example, FIG. 13 illustrates a flowchart of example sequences of acts in accordance with one or more embodiments.

FIG. 13 illustrates a flowchart of a series of acts 1300 for generating a digital presentation from a digital presentation outline in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium stores instructions thereon that, when executed by at least one processor, cause a computing device to perform the acts of FIG. 13. In some embodiments, a system performs the acts of FIG. 13. For example, in one or more embodiments, a system includes at least one memory device. The system further includes at least one server device configured to cause the system to perform the acts of FIG. 13.

The series of acts 1300 includes an act 1302 of generating a set of insights from data extracted from an analytics application. Further, the series of acts 1300 includes an act 1304 of generating narrative grouping structures from the set of insights. Moreover, the series of acts 1300 includes an act 1306 of generating a digital outline according to the narrative grouping structures. Further, the series of acts 1300 includes an act 1308 of generating a digital presentation based on the digital presentation outline.

In particular, the act 1302 includes generating, utilizing an intelligent captioning model, a set of insights from data extracted from an analytics application, the set of insights comprising dimensions, metrics, values, and visualizations. Further, the act 1304 includes generating narrative grouping structures from the set of insights by grouping insights together based on similarity scores of the set of insights. Moreover, the act 1306 includes generating a digital presentation outline according to the narrative grouping structures from the set of insights. Further, the act 1308 includes generating a digital presentation based on the digital presentation outline, the digital presentation comprising a digital slide corresponding to an insight from the set of insights.

In one or more embodiments, the series of acts 1300 includes receiving a user specified parameter that indicates specific dimension values of interest from the data extracted from the analytics application. In addition, in one or more embodiments, the series of acts 1300 includes filtering the set of insights down to a subset of insights based on the user specified parameter. Further, in one or more embodiments, the series of acts 1300 includes generating the narrative grouping structures from the subset of insights. Further, in some embodiments, the series of acts 1300 includes ranking, utilizing a ranking model, the set of insights according to the dimensions, metrics, values, and visualizations, wherein, ranking the set of insights comprises ranking according to a position of a visualization in the analytics application and a frequency of a dimension in the analytics application.

Moreover, in one or more embodiments, the series of acts 1300 includes generating a first text representation of a first insight from the set of insights. Further, in one or more embodiments, the series of acts 1300 includes generating a second text representation of a second insight form the set of insights. Moreover, in one or more embodiments, the series of acts 1300 includes comparing the first text representation with the second text representation to determine a measure of similarity between the first insight and the second insight.

Further, in one or more embodiments, the series of acts 1300 includes based on the measure of similarity satisfying a highly related threshold, grouping the first insight and the second insight together to be placed in the digital slide of the digital presentation. Moreover, in one or more embodiments, the series of acts 1300 includes based on the measure of similarity satisfying a related threshold, grouping the first insight and the second insight together to be placed in a same section of the digital presentation. Additionally, in one or more embodiments, the series of acts 1300 includes based on the measure of similarity failing to satisfy the related threshold, separating the first insight and the second insight to be placed in different sections of the digital presentation.

In one or more embodiments, the series of acts 1300 includes converting, utilizing a presentation generation model, the digital presentation outline into the digital presentation by selecting a digital presentation template in response to user input. Moreover, in one or more embodiments, series of acts 1300 includes identifying a first target layout for a first digital slide of the digital presentation based on a first insight. For example, in one or more embodiments, the series of acts 1300 includes identifying a second target layout for a second digital slide of the digital presentation based on a second insight. Moreover, in one or more embodiments, series of acts 1300 includes mapping the digital presentation outline into the digital presentation comprising the first target layout for the first insight and the second target layout for the second insight.

In addition, in one or more embodiments, the series of acts 1300 includes based on a threshold amount of space for a digital slide of the digital presentation, hiding content from the digital presentation outline to map to the digital slide of the digital presentation. Further, in one or more embodiments, the series of acts 1300 includes generating a label for the digital slide that indicates an amount of hidden content in the digital slide. Further, in some embodiments, the series of acts 1300 includes based on the hidden content, generating presenter notes from the digital presentation outline to provide for display in a presenter note interface of the digital presentation. Moreover, in some embodiments, the series of acts 1300 includes receiving a user prompt to generate an additional insight via a digital presentation prompting interface. In one or more embodiments, the series of acts 1300 includes generating an additional digital slide to add to the digital presentation, wherein the additional digital slide captures the additional insight.

Furthermore, in one or more embodiments, the series of acts 1300 includes generating, utilizing the intelligent captioning model, a set of insights from data extracted from an analytics application. Moreover, in one or more embodiments, the series of acts 1300 includes receiving a user specified parameter that indicates specific dimension values of interest from the data extracted from the analytics application. Moreover, in one or more embodiments, the series of acts 1300 includes filtering the set of insights down to a subset of insights based on the user specified parameter. Further, in one or more embodiments, the series of acts 1300 includes generating narrative grouping structures from the subset of insights by grouping insights together based on similarity scores of the subset of insights. In one or more embodiments, the series of acts 1300 includes generating a digital presentation according to the narrative grouping structures, the digital presentation comprising digital slides corresponding to insights.

Moreover, in one or more embodiments, the series of acts 1300 includes comparing a first insight with a second insight. Further, in one or more embodiments, the series of acts 1300 includes generating a measure of similarity between the first insight and the second insight.

Moreover, in some embodiments, the series of acts 1300 includes determining the measure of similarity satisfies a highly related threshold. Further, in some embodiments, the series of acts 1300 includes generating a digital presentation outline comprising a narrative grouping structure that groups together the first insight and the second insight. Moreover, in some embodiments, the series of acts 1300 includes determining the measure of similarity satisfies a related threshold. In some embodiments, the series of acts 1300 includes generating a digital presentation outline comprising a narrative grouping structure that places the first insight and the second insight in a same section.

Furthermore, in one or more embodiments, the series of acts 1300 includes identifying a target layout for a digital slide of the digital presentation based on an insight from the subset of insights. Moreover, in one or more embodiments, the series of acts 1300 includes based on a threshold amount of space for the digital slide of the digital presentation, hiding data associated with the insight in the digital slide of the digital presentation. Further, in one or more embodiments, the series of acts 1300 includes generating a label for the digital slide that indicates an amount of hidden content. In one or more embodiments, the series of acts 1300 includes generating the digital presentation comprising the digital slide with the target layout and the label for the digital slide that indicates the amount of hidden content.

In addition, in one or more embodiments, the series of acts 1300 includes receiving, via a digital presentation prompting interface, a user prompt that compares an existing insight in the digital presentation with an additional insight. Further, in one or more embodiments, the series of acts 1300 includes generating an additional digital slide to add to the digital presentation, wherein the additional digital slide captures a comparison of the existing insight with the additional insight.

Further, in some embodiments, the series of acts 1300 includes generating, utilizing an intelligent captioning model, a set of insights from data extracted from an analytics application. Furthermore, in one or more embodiments, the series of acts 1300 includes generating narrative grouping structures from the set of insights by grouping insights based on similarity scores of the set of insights. Moreover, in one or more embodiments, the series of acts 1300 includes generating a digital presentation according to the narrative grouping structures. Further, in one or more embodiments, the series of acts 1300 includes receiving a user prompt to generate an additional insight via a digital presentation prompting interface. Further, in some embodiments, the series of acts 1300 includes generating an additional digital slide to add to the digital presentation, wherein the additional digital slide captures the additional insight.

Furthermore, in one or more embodiments, the series of acts 1300 includes receiving a user specified parameter that indicates specific dimension values of interest from the data extracted from the analytics application. Furthermore, in one or more embodiments, the series of acts 1300 includes ranking the set of insights according to the user specified parameter. Moreover, in one or more embodiments, the series of acts 1300 includes selecting a subset of insights from the set of insights based on the ranking. In one or more embodiments, the series of acts 1300 includes generating the narrative grouping structures from the subset of insights.

Furthermore, in one or more embodiments, the series of acts 1300 includes comparing a new insight in the analytics application with an existing insight from the data extracted from the analytics application. Furthermore, in one or more embodiments, the series of acts 1300 includes generating the additional digital slide comprising a comparison of the new insight with the existing insight. Moreover, in one or more embodiments, the series of acts 1300 includes adding the additional digital slide to the digital presentation to present the digital presentation with the additional digital slide to a user of a computing device. In one or more embodiments, the series of acts 1300 includes providing the digital presentation prompting interface to the user of the computing device for additional user prompts.

Furthermore, in one or more embodiments, the series of acts 1300 includes receiving an additional user prompt via the digital presentation prompting interface. Furthermore, in one or more embodiments, the series of acts 1300 includes comparing updated data in the analytics application with the data extracted from the analytics application. Moreover, in one or more embodiments, the series of acts 1300 includes updating existing slides in the digital presentation based on the comparison of the updated data with the data.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates a block diagram of an example computing device 1400 that may be configured to perform one or more of the processes described above. One will appreciate that one or more computing devices, such as the computing device 1400 may represent the computing devices described above (e.g., the server device(s) 104 and/or the client device 110). In one or more embodiments, the computing device 1400 may be a mobile device (e.g., a mobile telephone, a smartphone, a PDA, a tablet, a laptop, a camera, a tracker, a watch, a wearable device). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 include hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 including storage for storing data or instructions. As an example, and not by way of limitation, the storage device 1406 can include a non-transitory storage medium described above. The storage device 1406 may include a hard disk drive (HDD), flash memory, a Universal Serial Bus (USB) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can include hardware, software, or both that connects components of computing device 1400 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
generating, utilizing an intelligent captioning model, a set of insights from data extracted from an analytics application, the set of insights comprising dimensions, metrics, values, and visualizations;
generating narrative grouping structures from the set of insights by grouping insights together based on similarity scores of the set of insights;
generating a digital presentation outline according to the narrative grouping structures from the set of insights; and
generating a digital presentation based on the digital presentation outline, the digital presentation comprising a digital slide corresponding to an insight from the set of insights.

2. The computer-implemented method of claim 1, further comprising:
receiving a user specified parameter that indicates specific dimension values of interest from the data extracted from the analytics application;
filtering the set of insights down to a subset of insights based on the user specified parameter; and
generating the narrative grouping structures from the subset of insights.

3. The computer-implemented method of claim 1, further comprising:
ranking, utilizing a ranking model, the set of insights according to the dimensions, metrics, values, and visualizations,
wherein, ranking the set of insights comprises ranking according to a position of a visualization in the analytics application and a frequency of a dimension in the analytics application.

4. The computer-implemented method of claim 1, wherein generating the narrative grouping structures comprises:
generating a first text representation of a first insight from the set of insights;
generating a second text representation of a second insight from the set of insights; and
comparing the first text representation with the second text representation to determine a measure of similarity between the first insight and the second insight.

5. The computer-implemented method of claim 4, further comprising:
based on the measure of similarity satisfying a highly related threshold, grouping the first insight and the second insight together to be placed in the digital slide of the digital presentation;
based on the measure of similarity satisfying a related threshold, grouping the first insight and the second insight together to be placed in a same section of the digital presentation; or
based on the measure of similarity failing to satisfy the related threshold, separating the first insight and the second insight to be placed in different sections of the digital presentation.

6. The computer-implemented method of claim 1, wherein generating the digital presentation based on the digital presentation outline comprises:
converting, utilizing a presentation generation model, the digital presentation outline into the digital presentation by:
selecting a digital presentation template in response to user input;
identifying a first target layout for a first digital slide of the digital presentation based on a first insight;
identifying a second target layout for a second digital slide of the digital presentation based on a second insight; and
mapping the digital presentation outline into the digital presentation comprising the first target layout for the first insight and the second target layout for the second insight.

7. The computer-implemented method of claim 1, further comprising:
based on a threshold amount of space for a digital slide of the digital presentation, hiding content from the digital presentation outline to map to the digital slide of the digital presentation; and
generating a label for the digital slide that indicates an amount of hidden content in the digital slide.

8. The computer-implemented method of claim 7, further comprising based on the hidden content, generating presenter notes from the digital presentation outline to provide for display in a presenter note interface of the digital presentation.

9. The computer-implemented method of claim 1, further comprising:
receiving a user prompt to generate an additional insight via a digital presentation prompting interface; and
generating an additional digital slide to add to the digital presentation, wherein the additional digital slide captures the additional insight.

10. A system comprising:
one or more memory devices comprising an intelligent captioning model; and
one or more processors configured to cause the system to:
generate, utilizing the intelligent captioning model, a set of insights from data extracted from an analytics application;
receive a user specified parameter that indicates specific dimension values of interest from the data extracted from the analytics application;
filter the set of insights down to a subset of insights based on the user specified parameter;
generate narrative grouping structures from the subset of insights by grouping insights together based on similarity scores of the subset of insights; and
generate a digital presentation according to the narrative grouping structures, the digital presentation comprising digital slides corresponding to insights.

11. The system of claim 10, wherein the one or more processors are configured to cause the system to generate the narrative grouping structures by:
comparing a first insight with a second insight; and
generating a measure of similarity between the first insight and the second insight.

12. The system of claim 11, wherein the one or more processors are configured to cause the system to:
determine the measure of similarity satisfies a highly related threshold; and
generate a digital presentation outline comprising a narrative grouping structure that groups together the first insight and the second insight.

13. The system of claim 11, wherein the one or more processors are configured to cause the system to:
determine the measure of similarity satisfies a related threshold; and
generate a digital presentation outline comprising a narrative grouping structure that places the first insight and the second insight in a same section.

14. The system of claim 10, wherein the one or more processors are configured to cause the system to:
identify a target layout for a digital slide of the digital presentation based on an insight from the subset of insights;
based on a threshold amount of space for the digital slide of the digital presentation, hide data associated with the insight in the digital slide of the digital presentation;
generate a label for the digital slide that indicates an amount of hidden content; and
generate the digital presentation comprising the digital slide with the target layout and the label for the digital slide that indicates the amount of hidden content.

15. The system of claim 10, wherein the one or more processors are configured to cause the system to:
receive, via a digital presentation prompting interface, a user prompt that compares an existing insight in the digital presentation with an additional insight; and
generate an additional digital slide to add to the digital presentation, wherein the additional digital slide captures a comparison of the existing insight with the additional insight.

16. A non-transitory computer-readable medium storing executable instructions which, when executed by at least one processing device, cause the at least one processing device to perform operations comprising:
generating, utilizing an intelligent captioning model, a set of insights from data extracted from an analytics application;
generating narrative grouping structures from the set of insights by grouping insights based on similarity scores of the set of insights;
generating a digital presentation according to the narrative grouping structures;
receiving a user prompt to generate an additional insight via a digital presentation prompting interface; and
generating an additional digital slide to add to the digital presentation, wherein the additional digital slide captures the additional insight.

17. The non-transitory computer-readable medium of claim 16, wherein the operations further comprise:
receiving a user specified parameter that indicates specific dimension values of interest from the data extracted from the analytics application;
ranking the set of insights according to the user specified parameter;
selecting a subset of insights from the set of insights based on the ranking; and
generating the narrative grouping structures from the subset of insights.

18. The non-transitory computer-readable medium of claim 16, wherein receiving the user prompt to generate the additional insight comprises:
comparing a new insight in the analytics application with an existing insight from the data extracted from the analytics application; and
generating the additional digital slide comprising a comparison of the new insight with the existing insight.

19. The non-transitory computer-readable medium of claim 18, wherein the operations further comprise:
adding the additional digital slide to the digital presentation to present the digital presentation with the additional digital slide to a user of a computing device; and
providing the digital presentation prompting interface to the user of the computing device for additional user prompts.

20. The non-transitory computer-readable medium of claim 19, wherein the operations further comprise:
receiving an additional user prompt via the digital presentation prompting interface;
comparing updated data in the analytics application with the data extracted from the analytics application; and
updating existing slides in the digital presentation based on the comparison of the updated data with the data.
